SEQUENCE LISTING (6 sequences)

SEQ ID NO: 1 - protein, 778 aa, Escherichia coli
MKQIRLLAQYYVDLMMKLGLVRFSMLLALALVVLAIVVQMAVTMVLHGQVESIDVIRSIFFGLLITPWAVYFLSVVVEQLEESRQRLSRLVQKLEEMRERDLSLNVQLKDNIAQLNQEIAVREKAEAELQETFGQLKIEIKEREETQIQLEQQSSFLRSFLDASPDLVFYRNEDKEFSGCNRAMELLTGKSEKQLVHLKPADVYSPEAAAKVIETDEKVFRHNVSLTYEQWLDYPDGRKACFEIRKVPYYDRVGKRHGLMGFGRDITERKRYQDALERASRDKTTFISTISHELRTPLNGIVGLSRILLDTELTAEQEKYLKTIHVSAVTLGNIFNDIIDMDKMERRKVQLDNQPVDFTSFLADLENLSALQAQQKGLRFNLEPTLPLPHQVITDGTRLRQILWNLISNAVKFTQQGQVTVRVRYDEGDMLHFEVEDSGIGIPQDELDKIFAMYYQVKDSHGGKPATGTGIGLAVSRRLAKNMGGDITVTSEQGKGSTFTLTIHAPSVAEEVDDAFDEDDMPLPALNVLLVEDIELNVIVARSVLEKLGNSVDVAMTGKAALEMFKPGEYDLVLLDIQLPDMTGLDISRELTKRYPREDLPPLVALTANVLKDKQEYLNAGMDDVLSKPLSVPALTAMIKKFWDTQDDEESTVTTEENSKSEALLDIPMLEQYLELVGPKLITDGLAVFEKMMPGYVSVLESNLTAQDKKGIVEEGHKIKGAAGSVGLRHLQQLGQQIQSPDLPAWEDNVGEWIEEMKEEWRHDVEVLKAWVAKATKK

SEQ ID NO: 2 - protein, 449 aa, Escherichia coli
MKFTQRLSLRVRLTLIFLILASVTWLLSSFVAWKQTTDNVDELFDTQLMLFAKRLSTLDLNEINAADRMAQTPNRLKHGHVDDDALTFAIFTHDGRMVLNDGDNGEDIPYSYQREGFADGQLVGEDDPWRFVWMTSPDGKYRIVVGQEWEYREDMALAIVAGQLIPWLVALPIMLIIMMVLLGRELAPLNKLALALRMRDPDSEKPLNATGVPSEVRPLVESLNQLFARTHAMMVRERRFTSDAAHELRSPLTALKVQTEVAQLSDDDPQARKKALLQLHSGIDRATRLVDQLLTLSRLDSLDNLQDVAEIPLEDLLQSSVMDIYHTAQQAKIDVRLTLNAHSIKRTGQPLLLSLLVRNLLDNAVRYSPQGSVVDVTLNADNFIVRDNGPGVTPEALARIGERFYRPPGQTATGSGLGLSIVQRIAKLHGMNVEFGNAEQGGFEAKVSW

SEQ ID NO: 3 - protein, 894 aa, Escherichia coli
MNNEPLRPDPDRLLEQTAAPHRGKLKVFFGACAGVGKTWAMLAEAQRLRAQGLDIVVGVVETHGRKDTAAMLEGLAVLPLKRQAYRGRHISEFDLDAALARRPALILMDELAHSNAPGSRHPKRWQDIEELLEAGIDVFTTVNVQHLESLNDVVSGVTGIQVRETVPDPFFDAADDVVLVDLPPDDLRQRLKEGKVYIAGQAERAIEHFFRKGNLIALRELALRRTADRVDEQMRAWRGHPGEEKVWHTRDAILLCIGHNTGSEKLVRAAARLASRLGSVWHAVYVETPALHRLPEKKRRAILSALRLAQELGAETATLSDPAEEKAVVRYAREHNLGKIILGRPASRRWWRRETFADRLARIAPDLDQVLVALDEPPARTINNAPDNRSFKDKWRVQIQGCVVAAALCAVITLIAMQWLMAFDAANLVMLYLLGVVVVALFYGRWPSVVATVINVVSFDLFFIAPRGTLAVSDVQYLLTFAVMLTVGLVIGNLTAGVRYQARVARYREQRTRHLYEMSKALAVGRSPQDIAATSEQFIASTFHARSQVLLPDDNGKLQPLTHPQGMTPWDDAIAQWSFDKGLPAGAGTDTLPGVPYQILPLKSGEKTYGLVVVEPGNLRQLMIPEQQRLLETFTLLVANALERLTLTASEEQARMASEREQIRNALLAALSHDLRTPLTVLFGQAEILTLDLASEGSPHARQASEIRQHVLNTTRLVNNLLDMARIQSGGFNLKKEWLTLEEVVGSALQMLEPGLSSPINLSLPEPLTLIHVDGPLFERVLINLLENAVKYAGAQAEIGIDAHVEGENLQLDVWDNGPGLPPGQEQTIFDKFARGNKESAVPGVGLGLAICRAIVDVHGGTITAFNRPEGGACFRVTLPQQTAPELEEFHEDM

SEQ ID NO: 4 - protein, 33 aa, Artificial Sequence
  Synthetic polypeptide
MKHHHHHHHHHGGLESTSLYKKAGSLVPRGSGS

SEQ ID NO: 5 - protein, 119 aa, Artificial Sequence
  Synthetic polypeptide
GSGSMKQIRLLAQYYVDLMMKLGLVRFSMLLALALVVLAIVVQMAVTMVLHGQVESIDVIRSIFFGLLITPWAVYFLSVVVEQLEESRQRLSRLVQKLEEMRERDLSLNVQLKDNIAQL

SEQ ID NO: 6 - protein, 107 aa, Artificial Sequence
  Synthetic polypeptide
MVQIQGCVVAAALCAVITLIAMQWLMAFDAANLVMLYLLGVVVVALFYGRWPSVVATVINVVSFDLFFIAPRGTLAVSDVQYLLTFAVMLTVGLVIGNLTAGVRYQA

(19) United States
(12) Patent Application Publication
(10) Pub. No.: US 2013/0078727 A1
(43) Pub. Date: Mar. 28, 2013

(54) METHODS AND COMPOSITIONS FOR NMR SPECTROSCOPIC ANALYSIS USING ISOTOPIC LABELING SCHEMES

(71) Applicants: Senyon Choe, Solana Beach, CA (US); Christian Klammt, La Jolla, CA (US); Witek Kwiatkowski, San Diego, CA (US); Innokentiy Maslennikov, La Jolla, CA (US)

(72) Inventors: Senyon Choe, Solana Beach, CA (US); Christian Klammt, La Jolla, CA (US); Witek Kwiatkowski, San Diego, CA (US); Innokentiy Maslennikov, La Jolla, CA (US)

(73) Assignees: JOINT CENTER FOR BIOSCIENCES, Incheon (KR); THE SALK INSTITUTE FOR BIOLOGICAL STUDIES, La Jolla, CA (US)

(21) Appl. No.: 13/604,509

(22) Filed: Sep. 5, 2012

Related U.S. Application Data
(63) Continuation of application No. PCT/US2011/274442, filed on Mar. 7, 2011.
(60) Provisional application No. 61/311,191, filed on Mar. 5, 2010.

(51) Int. Cl. G01N 24/08; G06F 17/00

(52) U.S. Cl. CPC G01N 24/087; G06F 17/00
USPC 436/86; 703/12

(57) ABSTRACT

Provided herein are methods and compositions for efficient accumulation of structural information (e.g., three dimensional structural information) for amino acid sequences.

### CROSS-REFERENCES TO RELATED APPLICATIONS

The present application claims priority to U.S. Provisional Patent Application No. 61/311,191, filed on Mar. 5, 2010, which is incorporated by reference in its entirety and for all purposes.

### STATEMENT AS TO RIGHTS TO INVENTIONS MADE UNDER FEDERALLY SPONSORED RESEARCH OR DEVELOPMENT

This invention was made with government support under GM74929 awarded by the National Institutes of Health. The Government has certain rights in the invention.

### BACKGROUND OF THE INVENTION

Despite impressive progress in structure determination of the integral membrane proteins (IMPs) by X-ray crystallography and NMR spectroscopy in recent years (see reviews (McLuskey, K. et al., Eur Biophys J (Oct. 14, 2009); Kim, H. K. et al., Progress in Nuclear Magnetic Resonance Spectroscopy, 2009, 55:335-360), only about 250 structures of unique IMPs have been determined so far, representing less than 1% of known protein structures. See e.g., White, S. H. Nature May 21, 2009, 459:344. In addition to problems with expression, solubilization and purification of IMPs, X-ray and NMR methods are hampered with inherent technical difficulties. Diffraction quality crystals of IMPs are very difficult to obtain because the solubilized protein-detergent complex does not usually form ordered crystal lattices. NMR spectroscopy as an alternative method to X-ray can target smaller IMPs, but the internal mobility of transmembrane (TM) helical bundles causes strong broadening of the signals and presents problems with signal assignment, spectra analysis, and detection of long-range interactions, which are necessary to build up the structure of the TM α-helical bundle. The spin label-based paramagnetic relaxation enhancement (PRE) approaches have been used to address the inherited paucity of long-distance constraints associated with the properties of the α-helical IMPs. See e.g., Battiste, J. L. et al., Biochemistry, May 9, 2000, 39:5355; Roosild, T. P. et al., Science, Feb. 25, 2005, 307:1317. However, the high experimental cost of isotope labeling by in vivo heterologous expression in cells of both prokaryotic and eukaryotic origins prohibits NMR structural studies for even well-expressed IMPs. The present invention addresses this and other problems in the art.

### BRIEF SUMMARY OF THE INVENTION

In one aspect, a method is provided for determining structural information (e.g., three-dimensional structural information) for an amino acid sequence. The method includes determining a plurality of different isotopic labeling schemes for an amino acid sequence. The method further includes synthesizing a plurality of isotopically labeled peptides. Each isotopically labeled peptide is isotopically labeled according to one of the plurality of different isotopic labeling schemes, and each isotopically labeled peptide includes the amino acid sequence. The plurality of isotopically labeled peptides are subjected to an NMR spectroscopic analysis thereby determining structural information (e.g., three-dimensional structural information) for the amino acid sequence.

In another aspect, a computer-implement method is provided for determining a plurality of different isotopic labeling schemes. Under the control of one or more computer systems configured with executable instructions, the method includes receiving user input specifying an amino acid sequence and an integer representing a number of different isotopic labeling schemes for the amino acid sequence. The method further includes determining each of the number of different isotopic labeling schemes for the amino acid sequence, and providing data to a user. The data provided to the user can include identification of each of the number of different isotopic labeling schemes for the amino acid sequence.

In yet another aspect, a computer-readable storage medium is provided for determining a plurality of different isotopic labeling schemes. The computer-readable storage medium has stored thereon instructions that, when executed by one or more processors of a computer system, cause the computer system to at least receive a user input specifying an amino acid sequence and an integer representing a number of different isotopic labeling schemes for the amino acid sequence. The computer system also can determine each of the number of different isotopic labeling schemes for the amino acid sequence. The computer system further provides data to a user. The data provided to the user can include identification of each of the number of different isotopic labeling schemes for the amino acid sequence.

In yet another aspect, a system is provided for determining a plurality of different isotopic labeling schemes. The system includes one or more processors, and memory including instructions executable by the one or more processors. When the instructions are executed by the one or more processors, the system at least receives a user input specifying an amino acid sequence and an integer representing a number of different isotopic labeling schemes for the amino acid sequence. The system further determines each of the number of different isotopic labeling schemes for the amino acid sequence. The system also provides data to a user. The data provided to the user can include identification of each of the number of different isotopic labeling schemes for the amino acid sequence.

### BRIEF DESCRIPTION OF THE DRAWINGS

FIG. 1 is a simplified block diagram of a computer system that may be used herein.

FIG. 2: Three classes of histidine kinase receptors (HKRs). (A) Schematic representation of TM domains of three classes of HKRs and (B) ribbon representation of 3D structures of the TM domains of E. coli HKRs ArcB (SEQ ID NO:1), QseC (SEQ ID NO:2), and KdpD (SEQ ID NO:3).

FIG. 3: [¹H-¹⁵N]-TROSY-HSQC spectra of ¹⁵N-labeled ArcB(1-115) expressed (A) in E. coli and (B) by CF synthesis. (A) The protein was expressed in E. coli, extracted and purified from cell membrane with the FC-12 detergent and the detergent was exchanged to LMPG. (B) The protein was synthesized in the p-CF mode and the precipitant was washed and solubilized in 5% LMPG. Cross-peaks denoted by arrows correspond to the tag linker residues in the E. coli-expressed protein. (C) Overlay of ¹³C DARR-NMR spectra (213.765 MHz) of uniformly ¹³C-labeled ArcB(1-115) expressed in p-CF reaction. Grey contours correspond to the spectra of the ArcB(1-115) sample, lyophilized after solubilization in LMPG (the same sample before lyophilization shows spectrum (B)). Black contours correspond to the spectra of washed but not solubilized precipitant of the p-CF reaction. The lines correspond to random coil ¹³C^{α}, ¹³C^{β} chemical shifts for valine (Val) and alanine (Ala), respectively; arrows show the regions corresponding to the α-helical conformation.

FIG. 4: The CDL strategy for the assignment of NMR spectra. (A) Amino acid-selective isotope labeling is used for “point-directed assignment”. The [¹H-¹⁵N] cross peak in HSQC will appear only if the second residue in a pair is ¹⁵N-labeled (second box tagged 1). The [¹H-¹⁵N] cross peak in the HSQC spectrum and the [¹H-¹⁵N-¹³C] cross peak in the HNCO spectrum will both appear only if the peptide group is double [¹³C, ¹⁵N]-labeled (third box tagged 2). (B) An example of combinatorial selective labeling for the determination of the type of amino acid for ¹H-¹⁵N cross-peaks. Five samples with different combinations of isotope labeling (“+” denotes labeled amino acid and “−” denotes non-labeled) are necessary and sufficient to define the amino acid type (out of 19 non-proline amino acids) for all cross peaks in the [¹H-¹⁵N]-HSQC spectrum. For every amino acid type the scheme defines a unique sequence of labeling across all 5 samples. This scheme is optimized for the occurrence of amino acids in human membrane proteins. The same scheme with the addition of proline could be used in selective ¹³C labeling with a uniform ¹⁵N-labeled background for the assignment of the type of the first amino acid in a pair simply by the detection of the HNCO cross peak. (C) Dual ¹⁵N/¹³C combinatorial selective labeling scheme designed specifically for backbone assignment of KdpD(396-502). (D) Assignment of ¹H-¹⁵N cross peaks of KdpD(397-502) using a combinatorial scheme of selective ¹³C, ¹⁵N labeling, presented in panel C. The overlays of [¹H-¹⁵N]-TROSY-HSQC (light grey contours) and [¹H-¹⁵N] projection of TROSY-HNCO (darker grey contours) spectra are shown for each sample (I-VI). Absence of a cross peak (tag “0”), a cross peak present in TROSY only (tag “1”), and cross peaks present in both the TROSY and the HNCO spectra (tag “2”) in each combinatorially labeled sample define the code (sequence of the tags) for every cross peak A, B, and C in a uniformly labeled sample. Comparison of the derived codes with the expected ones (according to the labeling scheme) determines unambiguous assignment for cross peaks with a unique code, and defines the type of the preceding and current amino acid for all cross peaks.

FIG. 5: Twenty superimposed structures of the TM domains of (A) ArcB(1-115), (Q) QseC(1-186), and (K) KdpD(397-502). Backbones are shown for the stable regions: ArcB(1-115)—residues 20-83, QseC(1-185)—residues 10-38 and 156-185, and KdpD(397-502)—residues 397-502. Consecutive TM helices are shown. Structures on the right are rotated 90° relative to the ones on the left.

FIG. 6: Comparison of (A) performance and (B) cost efficiency of the CF system with the standard E. coli system. A) includes SDS-PAGE showing marker (M); CF RM before reaction at Oh (1); CF RM after ArcB(1-115) expression at 15 h (2); precipitate after ArcB(1-115) p-CF (3); E. coli (EC) expressed ArcB(1-115) after extraction, purification, Tag cleavage, SEC, detergent exchange on Q-Sepharose® and concentration (4); arrow indicates ArcB(1-115).

FIG. 7: Characterization of the ArcB(1-115), QseC(1-185), and [C402, 409S]-KdpD(397-502) expressed in the CF system. (A) SDS-PAGE analysis of 0.5 ul NMR samples from 1 ml CF precipitate solubilized in 1-myristoyl-2-hydroxy-sn-glycero-3-[phospho-rac-(1-glycerol)] (LMPG): Marker (lane M), ArcB(1-115) (lane A), QseC(1-185) (lane Q), and [C402,409S]-KdpD(397-502) (lane K). Proteins of interest are indicated by arrows. (B-G) Chromatograms and spectra for ArcB(1-115) (B,E), QseC(1-185) (C,F), and [C402,409S]-KdpD(397-502) (D,G), (B-D) Analysis of protein-detergent complexes (PDC) performed by light scattering (LS) coupled with size-exclusion gel chromatography and refracting index measurements. Black lines correspond to the LS signal; other lines show average molar masses of the complexes A, Q and K, of the detergent component LMPG, and of the protein component in PDC, respectively. (E-G) [¹⁵N-¹H]-TROSY-HSQC spectra of HKR's TM domains, expressed by CIF synthesis and solubilized in 5% LMPG.

FIG. 8: Analysis of the secondary structure of the [C402, 409S]-KdpD(397-502) precipitated during p-CF synthesis. (A) 2D ¹³C DARR-NMR spectrum: the p-CF reaction pellet (2 mg) was washed with 20 mM Mes-BisTris buffer, pH 6.0 and was loaded into a 4 mm MAS rotor. The spectrum was acquired on a Bruker Avance 850 spectrometer (213.765 MHz for ¹³C) using a 4 mm MAS-DVT probe at 273 K and the 14 KHz spinning rate. The lines correspond to the random coil ¹³C^{a}, ¹³C^{β} chemical shift values for valine (Val) and alanine (Ala), respectively; arrows show the regions corresponding to α-helical conformation. (B and C) [¹⁵N, ¹H]-TROSY-HSQC spectra of [C402, 409S]-KdpD(397-502). The protein was expressed and precipitated during CF reaction and solubilized with 5% LMPG (1-myristoyl-2-hydroxy-sn-glycero-3-[phospho-rac-(1-glycerol)]) in 20 mM Mes-BisTris buffer, pH 6.0. (B) The spectrum of protein expressed and solubilized in H₂O; (C) The overlay of spectra of the proteins expressed/solubilized in H₂O/D₂O or D₂O/H₂O. The protein concentration was 0.3 mM in all samples. The spectra were measured at 45° C. on a 700 MHz Bruker NMR instrument with 400 increments and 8 scans per increment. The measurements were started at 10 min after solubilization of the protein.

FIG. 9: [¹⁵N, ¹H]-TROSY-HSQC spectra of ArcB(1-115). Protein was expressed and precipitated during CF reaction and solubilized with 5% LMPG (1-myristoyl-2-hydroxy-sn-glycero-3-[phospho-rac-(1-glycerol)]) in 20 mM Bis-Tris buffer, pH 6.0. Protein was expressed/solubilized in (A) H₂O/H₂O; (B) D₂O/H₂O; (C) H₂O/D₂O; (D) D₂O/D₂O. Protein concentration was 0.3 mM in all samples. The spectra were measured at 45° C. on a 700 MHz Bruker NMR instrument with 320 increments and 8 scans per increment. The measurements were started 10 min after solubilization of the protein.

FIG. 10: Backbone amide groups of [C402, 409S]-KdpD(397-502) and ArcB(1-115) with slow H-D exchange. TM helical regions are shown as grey bars above the amino acid sequences. Residues with HN protons demonstrating slow exchange with solvent are marked with black bars below the sequence. The exchange rates were estimated by calculating the ratio between integral intensities of the cross peaks in [¹⁵N, ¹H]-TROSY-HSQC spectra of samples solubilized in H₂O and in 100% D₂O. The ¹⁵N-labeled proteins were expressed and precipitated during CF reaction in H₂O and solubilized with 5% LMPG in 20 mM Mes-Bis-Tris, pH 6.0, H₂O or 100% D₂O buffer. The measurements were started 10 min after protein solubilization.

FIG. 11: Summary of structural NMR data collected for ArcB(1-115) expressed in the E. coli (top) and in the CF system (bottom): (A) backbone NOEs, (B) deviation of ¹³C^{α} chemical shifts from the “random coil” values. The sequence shows residues 30-148 of the His9 tag and ArcB (SEQ ID NO: 5).

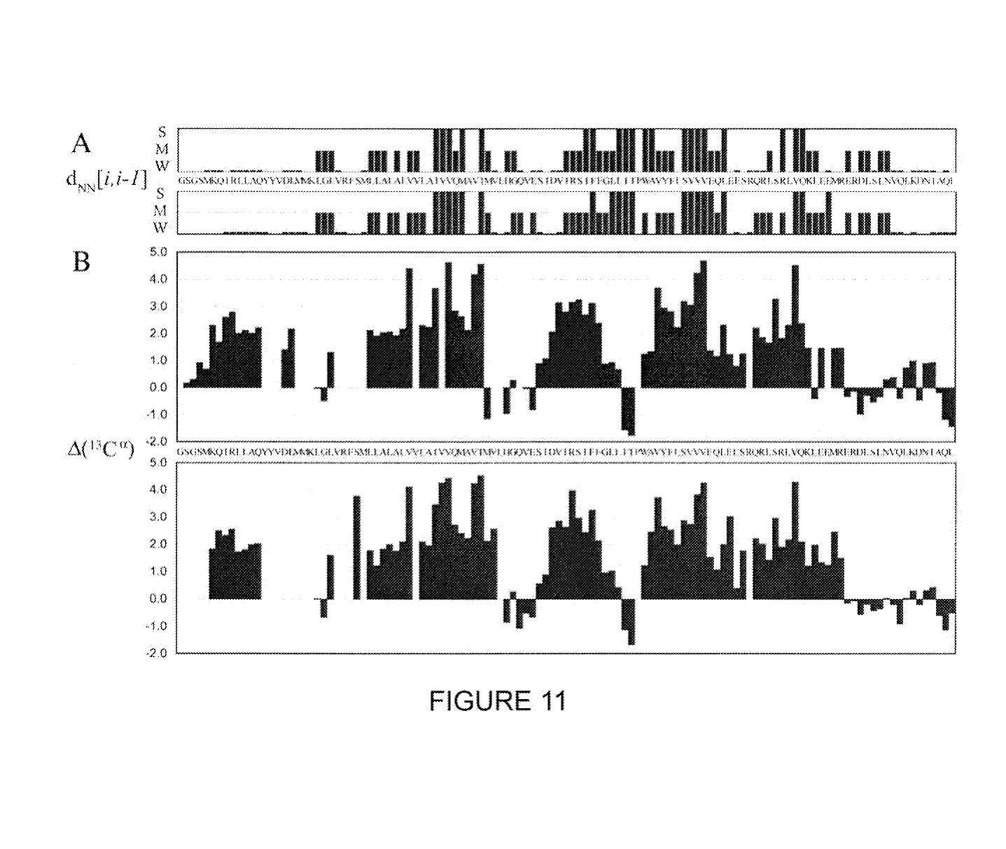

FIG. 12: The combinatorial assignment of KdpD(396-502). The residues with unambiguously assigned ¹H^{N} and ¹⁵N^{H} resonances are highlighted in dark grey. The residues that could be assigned to two [¹H-¹⁵N] cross peaks are highlighted in light grey. The type of amino acid was assigned for all [¹H-¹⁵N] cross peaks.

FIG. 13: A stereo view of 20 superimposed structures of (A) ArcB(1-115), (O) QseC(1-186), and (K) KdpD(397-502). Backbones are shown for the stable regions: ArcB(1-115)—residues 20-83, QseC(1-185)—residues 10-38 and 156-185, and KdpD(397-502)—residues 397-502. Consecutive TM helices are shown. Structures in the stereo pairs on the right are rotated 90° relative to the ones on the left.

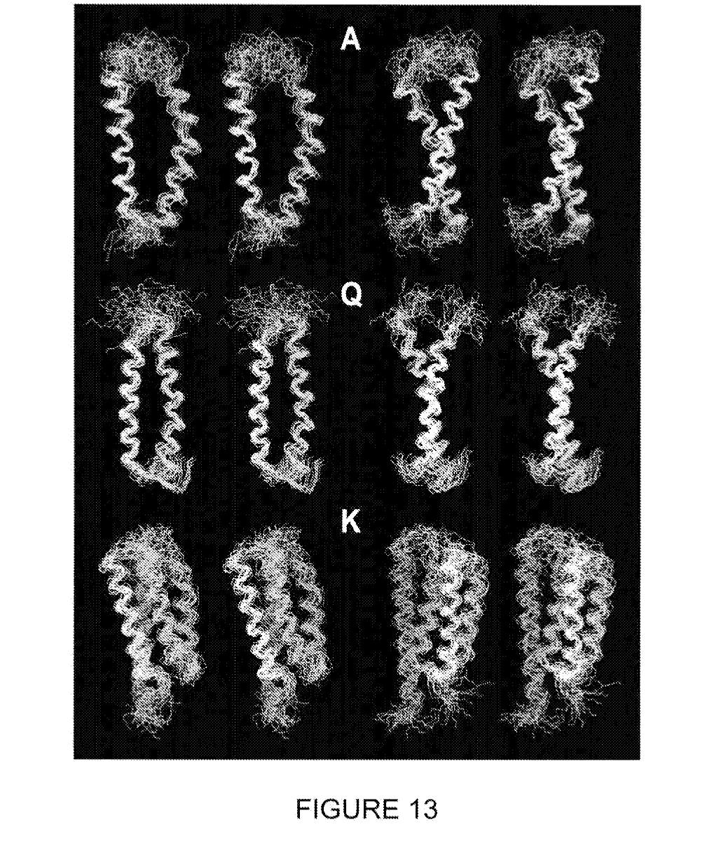

FIG. 14: Evaluation of 16 randomly selected hIMPs. (A) List of 16 selected small size hIMPs, swiss-prot access numbers are given in brackets. (B) Analysis of 16 cell-free expressed hIMPs by western blot and coomassie stain. Numbers of transmembrane helices (#TMH) are indicated. NMR spectral quality information is indicated as good (G), fair (F) or poor (P) below the gel. (C) Summary for CF expression level, detergent solubilization test and NMR quality for initially tested 16 human MPs.

FIG. 15: NMR spectral quality and N-H backbone assignment for 6 hIMPs. [¹H,¹⁵N]-TROSY-HSQC spectra with assignment for 6 hIMPs selected for solution structure analysis in LMPG micelles. Assignment was obtained by CF combinatorial dual labeling (CDL) strategy (Maslennikov et al. 2010) in combination with sequential assignment strategies. Protein names are indicated and screening numbers are given in parentheses. 0.1-0.3 mM hIMPs were solubilized in 2-3% LMPG, MES-Bis-Tris buffer, pH 6.0, and measured at 310K on a 700 MHz spectrometer equipped with a cryogenic probe.

FIG. 16: Solution NMR structures of 6 hIMPs. Structures were calculated by Cyana using distance information obtained from NOEs and paramagnetic relaxation enhancement (PRE) measurements. TM helices are shown. The name of the proteins is given and the hIMP code name is indicated in parentheses.

### DETAILED DESCRIPTION OF THE INVENTION

### I. Methods for Determining Structural Information for an Amino Acid Sequence

In one aspect, a method is provided for determining structural information, such as three-dimensional structural information, for an amino acid sequence. In some embodiments, the structural information is secondary or tertiary peptide structural information. In some embodiments, alpha helix structural information is determined, such as the location of one or more alpha helix structures in the amino acid sequence. The method of providing structural information includes determining a plurality of different isotopic labeling schemes for an amino acid sequence. The method further includes synthesizing a plurality of isotopically labeled peptides. Each isotopically labeled peptide is isotopically labeled according to one of the plurality of different isotopic labeling schemes, and each isotopically labeled peptide includes the amino acid sequence. The plurality of isotopically labeled peptides are subjected to an NMR spectroscopic analysis thereby determining three-dimensional structural information for the amino acid sequence.

An “amino acid sequence” refers to a polymer in which the monomers are amino acids and are joined together through amide bonds. An amino acid sequence may be or form part of a protein, polypeptide or peptide. When the amino acids are α-amino acids, either the L-optical isomer or the D-optical isomer can be used. Additionally, unnatural amino acids, for example, β-alanine, phenylglycine and homoarginine are also included. The amino acids may be either the D- or L-isomer. In some embodiments, the amino acids are L-isomers.

The term “peptide,” as used herein, has the meaning commonly given it in the art and includes polypeptides, proteins, enzymes, glycoproteins, hormones, receptors, antigens, antibodies, growth factors, etc., without limitation. In some embodiments, the peptide has an amino acid sequence that is a membrane protein sequence. “Peptide” includes both natural and synthetic peptides produced or isolated by any means known in the art. Non-natural peptides are also encompassed by this term. Thus, for example, a peptide may contain one or more mutations in the amino acid sequence of its backbone. Peptides may also bear unnatural groups added as probes or to modify protein characteristics. These groups may be added by chemical or microbial modification of the protein or one of its subunits. Additional variations on the term “peptide” will be apparent to those of skill in the art.

The term “three dimensional structural information,” as used herein, refers to information regarding the biomolecular structure of the isotopically labeled peptides. For example, the three dimensional structural information can include identification of secondary, tertiary and/or quaternary structure of a peptide. In some embodiments, the structural information can include relative three dimensional spatial orientation of each amino acid in the amino acid sequence. The structural information may also identify alpha helices, (3-sheets, or other structural motifs for all or a portion of a peptide chain of amino acids. As further described herein, this information can be acquired using methods generally known in the art, such as, e.g., NMR spectroscopy.

An “isotopic labeling scheme,” as used herein, refers to a designation of isotopic labels at specific atom positions within the amino acid sequence. Different isotopic labeling schemes can be determined for the amino acid sequence. For example, a first isotopic labeling scheme provides a first designation (e.g., a first pattern) of isotopic labels at specific atom positions within the amino acid sequence, a second isotopic labeling scheme provides a second designation (e.g., a second pattern) of isotopic labels at specific atom positions within the amino acid sequence, and optionally additional isotopic labeling schemes provide additional designations (e.g., additional patterns) of isotopic labels at specific atom positions within the given amino acid sequence. The first and second (and optionally additional) isotopic labeling schemes with designations of isotopic labels at specific atom positions within the given amino acid sequence are reflected in, what is referred to herein, as “different isotopic labeling schemes.” Thus, each different isotopic labeling scheme may include the amino acid sequence itself and a unique designation of isotopic labels at specific atom positions within the amino acid sequence. As described further herein, the plurality of different isotopic labeling schemes can be determined as part of a computer-implemented method that, for example, can calculate the labeling schemes using a variety of input parameters, such as the amino acid sequence and the number of desired different isotopic labeling schemes for NMR spectroscopic analysis.

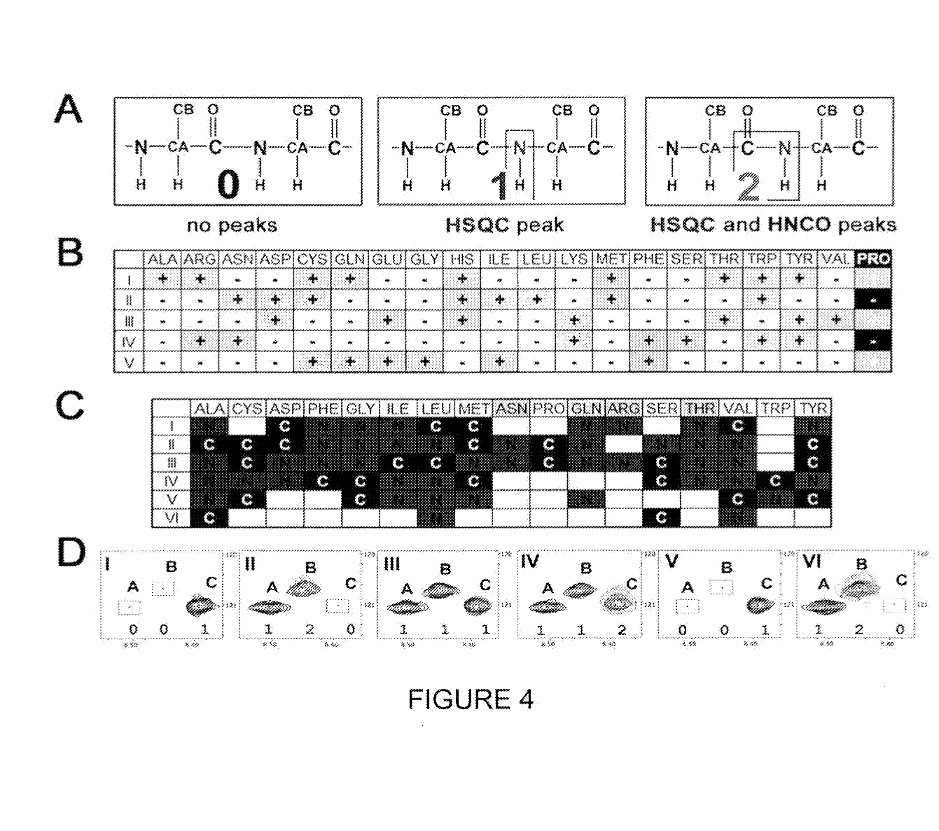

An example of isotopic labeling schemes with designations (e.g., patterns) of isotopic labels at specific atom positions within a given amino acid sequence is provided in FIG. 4C. The type of isotopic labeling scheme provided in FIG. 4C is also referred to herein as a “combinatorial selective labeling scheme” (or a “dual combinatorial selective labeling scheme” or a “dual ¹⁵N/¹³C combinatorial selective labeling scheme”). In FIG. 4C, six isotopic labeling schemes with designations are provided that are set forth as six isotopically labeled peptides. Each isotopically labeled peptide has the same amino acid sequence with a unique isotopic labeling scheme. Each of these plurality of isotopically labeled peptides are synthesized (e.g., expressed in vitro) thereby providing six isotopically labeled peptides that are subsequently subjected to an NMR spectroscopic analysis thereby determining three dimensional structural information for the amino acid sequence.

As disclosed above, the method further includes synthesizing a plurality of isotopically labeled peptides. Methods of synthesizing the peptides will be generally understood by one of ordinary skill in the art. In some embodiments, peptides can be produced using cell-free protein synthesis methods generally well known in the art. Peptides can be expressed in vitro using E. coli expression systems. Alternatively, some peptides can be synthesized using well known techniques, such as liquid-phase or solid-phase peptide synthesis.

Each isotopically labeled peptide is isotopically labeled according to one of the plurality of different isotopic labeling schemes, and each isotopically labeled peptide comprises the amino acid sequence. Methods for isotopically labeling peptides are generally well known in the art. As is known in the art, specific atoms in a peptide can be replaced with an isotope of that atom. For example, a ¹²C carbon in a peptide can be replaced with a ¹³C carbon. As described herein, nitrogens in the peptides can also be isotopically labeled. It will be understood that other atoms can be isotopically labeled, for example, to facilitate identification of three-dimensional structural information of the peptides.

As shown for example in FIG. 4C, the isotopic labeling scheme may be a ¹⁵N and ¹³C isotopic labeling scheme. In a ¹⁵N and ¹³C isotopic labeling scheme, specific nitrogen atoms and carbon atoms within the amino acid sequence are identified for labeling with ¹⁵N or ¹³C, respectively, to form an isotopically labeled peptide. In some embodiments, the isotopic labeling scheme is a ¹⁵N^{H} and ¹³C^{O} isotopic labeling scheme, wherein specific peptide backbone nitrogens and carbons are identified for labeling with ¹⁵N or ¹³C, respectively, to form an isotopic backbone labeled peptide.

In some embodiments, determining the different isotopic labeling schemes can involve minimizing the number of the plurality of isotopically labeled peptides necessary to determine three dimensional structural information of the amino acid sequence. For one amino acid sequence, a very large number (e.g., on the order of millions) of possible labeling schemes can be contemplated. It is typically impractical to experimentally produce each of the possible labeling schemes where the number of isotopic labeling schemes is very large. Thus, one embodiment of the methods disclosed herein is the identification of a practical or desired number of different isotopic labeling schemes. These isotopic labeling schemes can be determined by the computer-algorithms disclosed herein, which select a number (e.g., a predetermined or desired number) of different labeling schemes that will, for example, maximize the number or amount of NMR peak assignments to pairs of amino acids in the amino acid sequence, minimize NMR spectra peak overlap, and/or reduce the amount of redundancy in the different isotopic labeling schemes. Thus, the combinatorial labeling strategy described herein may have the advantage of requiring less time, expense and effort in synthesizing and analyzing large numbers of isotopically labeled proteins.

In some embodiments, the isotopic labeling schemes are designed to minimize the NMR spectra peak abundance resulting from the NMR spectroscopic analysis. Depending, for example, on which carbons and/or nitrogens are labeled, one isotopically labeled peptide may produce more NMR spectra peaks (e.g., a higher abundance) than another isotopically labeled peptide having the same amino acid sequence. To determine the optimum combination of different isotopic labeling schemes to minimize the NMR spectra peak abundance resulting from the NMR spectroscopic analysis, the methods disclosed herein can account for this potential discrepancy in the number of peaks produced from each member of a plurality of isotopically labeled peptides. Thus, in some embodiments, the methods select the optimum combination of different isotopic labeling schemes from the large number of possible labeling schemes for a given amino acid sequence to minimize the NMR spectra peak abundance resulting from the NMR spectroscopic analysis.

In other embodiments, the isotopic labeling schemes are designed to minimize overlap between NMR spectra peaks resulting from the NMR spectroscopic analysis. Based on a predicted isotopic labeling scheme of an amino acid sequence, the methods disclosed herein can calculate or determine at what resonances the NMR spectra peaks may be detected during NMR spectroscopic analysis. Considering the predicted resonance peaks, the different isotopic labeling schemes may be selected to minimize the amount of overlap between the different NMR peaks detected during NMR spectroscopic analysis. This minimization of spectral overlap can result in quicker and more accurate data analysis, as compared to analyzing spectra with more or greater spectral overlap among NMR peaks.

In some embodiments, the number of isotopically labeled peptides desired for sufficient three dimensional structural information for the amino acid sequence is 2, 3, 4, 5, 6, 7, 8, 9, 10, 11, 12, 13, 14, 15, 16, 17, 18, 19, 20, 21, 22, 23, 24, 25, 26, 27, 28, 29 or 30. In some embodiments, the number of isotopically labeled peptides desired for sufficient three-dimensional structural information for the amino acid sequence is less than 25, 20, 15, 12, 10, 9, 8, 7, 6, 5, 4, or 3. In some embodiments, the number of isotopically labeled peptides desired for sufficient three-dimensional structural information for the amino acid sequence is less than 12, 10, 8, or 6.

Any appropriate NMR spectroscopic analysis may be employed in the methods provided herein. In general, where an isotopically labeled peptide is subjected to an NMR spectroscopic analysis, signals are obtained and compared, so as to determine the assignment of the signals. Examples of useful NMR spectroscopic analysis include HNCA, HSQC, HMQC, CH-COSY, CBCANH, CBCA(CO)NH, HNCO, HN(CA)CO, HNHA, H(CACO)NH, HCACO, ¹⁵N-edited NOESY-HSQC, ¹³C-edited NOESY-HSQC, ¹³C/¹⁵N-edited HMQC-NOESY-HMQC, ¹³C/¹³C-edited HMQC-NOESY-HMQC, ¹⁵N/¹⁵N-edited HSQC-NOESY-HSQC (Cavanagh, W. J., et al., PrOTEIN NMR SPECTROSCOPY. PRINCIPLES AND PRACTICE, Academic Press (1996)), HN(CO)CACB, HN(CA)CB, HN(COCA)CB (Yamazaki, T., et al., J. Am. Chem. Soc., 1994, 116:11655-11666), H(CCO)NH, C(CO)NH (Grzesiek, S., et al., J. Magn. Reson. B, 1993, 101:114-119), CRIPT, CRINEPT (Riek, R., et al., Proc. Natl. Acad. Sci. USA., 1999, 96:4918-4923), HMBC, HBHA(CBCACO)NH (Evans J. N. S., BIOMOLECULARNMR SPECTROSCOPY. Oxford University Press (1995) 71), INEPT (Morris, G. A., et al., J. Am. Chem. Soc., 1979, 101:760-762), HNCACB (Wittekind, M., et al., J. Magn. Reson. B, 1993, 101:201), HN(CO)HB (Grzesiek, S., et al., J. Magn. Reson., 1992, 96:215-222), HNHB (Archer, S. J., et al., J. Magn. Reson., 1991, 95:636-641), HBHA(CBCA)NH (Wang, A. C., et al., J. Magn. Reson. B, 1994, 105:196-198), HN(CA)HA (Kay, L. E., et al., J. Magn. Reson., 1992, 98:443-450), HCCH-TOCSY (Bax, A., et al., J. Magn. Reson., 1990, 88:425-431), TROSY (Pervushin, K., et al., Proc. Natl. Acad. Sci. USA, 1997, 94:12366-12371), ¹³C/¹⁵N-edited HMQC-NOESY-HSQC (Jerala R, et al., J. Magn. Reson., 1995, 108:294-298), HN(CA)NH (Ikegami, T., et al., J. Magn. Reson., 1997, 124:214-217), and HN(COCA)NH (Grzesiek, S., et al., J. Biomol. NMR, 1993, 3:627-638).

In some embodiments, the NMR spectroscopic analysis includes TROSY-NMR (e.g., TROSY-HSQC NMR) spectroscopic analysis and HNCO NMR spectroscopic analysis. In other embodiments, the NMR spectroscopic analysis includes HSQC NMR spectroscopic analysis and HNCO NMR spectroscopic analysis. As described further herein, the combinatorial selective labeling schemes can be used in conjunction with the NMR techniques to produce NMR cross-peaks that facilitate identifying structural information about an amino acid sequence.

One of ordinary skill in the art will appreciate that the disclosed methods of determining structural information for an amino acid sequence can be used in conjunction with other methods, aspects and embodiments disclosed herein and vice versa. For example, the disclosed methods can be used with cell-free (CF) synthesis systems that can produce integral membrane proteins in a stable, structural configuration. In some embodiments, the methods disclosed herein may provide some, but not all, of the information necessary to determine the structure of an isotopically labeled peptide. Other traditional NMR structural analysis techniques can be used to facilitate in finalizing structural information about the amino acid sequence. In addition, other well-known techniques for calculating structure of a peptide can be used, such as paramagnetic resonance techniques.

### II. Methods for Determining a Plurality of Different Isotopic Labeling Schemes for an Amino Acid Sequence

In another aspect, a computer-implement method is provided for determining a plurality of different isotopic labeling schemes. Under the control of one or more computer systems configured with executable instructions, the method includes receiving user input specifying an amino acid sequence and an integer representing a number of different isotopic labeling schemes for the amino acid sequence. The method further includes determining each of the number of different isotopic labeling schemes for the amino acid sequence, and providing data to a user. The data provided to the user can include identification of each of the number of different isotopic labeling schemes for the amino acid sequence. As will be appreciated by one of ordinary skill in the art, this section can include certain aspects of the previous section regarding methods for determining structural information (e.g., three-dimensional structural information) for an amino acid sequence. In addition, this section further includes description of methods described herein that can be used to determine a plurality of different isotopic labeling schemes for an amino acid sequence which is applicable to other methods, aspects and embodiments disclosed above and below (e.g., methods for determining three dimensional structural information.

The computer-implemented methods described herein can include receiving an input from a user. In one embodiment, the user can input a known amino acid sequence. The methods described herein can be used for any appropriate amino acid sequence capable of being analyzed using NMR spectroscopy. The number of amino acids in the amino acid can range from one to hundreds. Typical sequences range from about 100 to about 300 amino acids in length. In certain embodiments, the amino acid sequence described herein can be a membrane protein sequence. In some embodiments, the amino acid sequence can have a sequence of amino acids that form an alpha-helix under certain environments. For example, portions or all of the amino acid sequence forms alpha helices in lipid membranes. In some embodiments, at least a portion of the amino acid sequence forms an alpha helix. In some embodiments, portions or all of the amino acid sequence forms β-sheet structures. In some embodiments, portions or all of the amino acid sequence forms globular protein in solution or other environments.

In some embodiments, a user can also input an integer representing (e.g., or corresponding to) a number (e.g., amount) of different isotopic labeling schemes that can be determined for the amino acid sequence using the methods described herein. The integer can be determined by a user that, e.g., considers time and other experimental factors known in the art that exist for analyzing a large number or amount of isotopically labeled peptides. The number of different isotopic labeling schemes, which typically corresponds to the number of the plurality of isotopically labeled peptides, can range from one to the maximum number of amino acids in the amino acid sequence. For example, if the amino acid sequence is 100 amino acids in length, the number of different isotopic labeling schemes can range from one to 100. In certain embodiments, the number of different isotopic labeling schemes typically ranges from 5 to 10. In some embodiments, the number of isotopically labeled peptides desired is 2, 3, 4, 5, 6, 7, 8, 9, 10, 11, 12, 13, 14, 15, 16, 17, 18, 19, 20, 21, 22, 23, 24, 25, 26, 27, 28, 29 or 30. In some embodiments, the number of isotopically labeled peptides is less than 25, 20, 15, 12, 10, 9, 8, 7, 6, 5, 4, or 3. In some embodiments, the number of isotopically labeled peptides is less than 12, 10, 8, or 6.

As disclosed herein, the methods can determine each of the number of different isotopic labeling schemes for an amino acid sequence by considering several parameters that result in an optimum or ideal set of labeling schemes. For example, each of the number of different isotopic labeling schemes can be selected to maximize assignments of NMR spectra peaks to amino acids in the amino acid sequence. In one embodiment, the determining of different isotopic labeling schemes can include predicting an NMR peak assignment for an amino acid in the amino acid sequence. Based on the isotopic labeling scheme of a peptide, a specific NMR spectrum can be predicted using known methods that indicate resonance frequencies for an atom or atoms in the peptide. For example, according to the combinatorial labeling scheme described herein, a pair of sequential amino acids in an amino acid can show an NMR cross-peak that is produced due to the specific isotopic labeling of that pair of sequential amino acids. As shown in FIG. 4D, for example, NMR cross-peaks can be detected using different NMR spectroscopic analyses. Depending on the amino acid sequence, the methods disclosed herein can produce an optimal set of different isotopic labeling schemes that allow for maximal assignment of peaks to amino acids. In certain embodiments, about 30% to about 40% of the NMR peaks (e.g., ¹N^{H}, ¹⁵N^{H} and ¹³C^{O} backbone resonances) can be assigned to a specific amino acid and/or pair of amino acids.

The methods for determining different isotopic labeling schemes can also include minimizing NMR spectra peak overlap. This aspect of the methods described herein includes predicting locations of the various NMR spectra peaks that will be detected from a particular isotopically labeled peptide and/or a plurality of isotopically labeled peptides. In determining each of the number of different isotopic labeling schemes, the methods herein can account for predicted NMR spectra peaks and design the isotopic labeling schemes so as to produce spectra with the fewest or near fewest amounts of peaks or spectral overlap in a spectrum. This minimization or reduction in spectral peaks can simplify analysis of NMR spectroscopic analyses, thereby decreasing analysis times and/or errors in assignment of peaks to specific amino acids.

In some embodiments, the methods for determining different isotopic labeling schemes include removing redundant isotopic labeling schemes from the number of different isotopic labeling schemes for the amino acid sequence. In determining each of the number of different isotopic labeling schemes, the computer algorithm selects isotopic labeling schemes out of a large number of possible labeling schemes (e.g., millions or more depending on the number and identity of amino acids in the amino acid sequence). Some of the possible labeling schemes can be redundant or substantially redundant in comparison to other possible labeling schemes. For example, of an amino acid sequence of 100 amino acids each of the amino acids may be labeled the same or substantially the same in two labeling schemes. The computer algorithm accounts for this redundancy and can remove redundant or substantially redundant labeling schemes from the final number of different isotopic labeling schemes determined by the methods disclosed herein.

As described above, the number of different isotopic labeling schemes can range broadly from one to the total number of amino acids present in the amino acid sequence. Generally, the number of different isotopic labeling schemes is selected to allow for increased efficiency in determining the structure of the amino acid sequence while also balancing the amount of experiment time needed to run the NMR spectroscopic analysis. In certain embodiments, the number of different isotopic labeling schemes can be 4, 5, 6, 7, 8, 9, 10, 11, 12, 13, 14, 15, 16, 17, 18, 19, 20. In some embodiments, the number of different isotopic labeling schemes can range from 5 to 10. In some embodiments, the number of different isotopic labeling schemes is 6 or 7 in number. In one embodiment, the number of different isotopic labeling schemes is 6. In one embodiment, the number of different isotopic labeling schemes is 7.

As described above, any appropriate NMR spectroscopic analysis may be employed in the methods provided herein. In certain embodiments, the methods can determine different isotopic labeling schemes that are ¹⁵N and ¹³C isotopic labeling schemes. In a ¹⁵N and ¹³C isotopic labeling scheme, specific nitrogen atoms and carbon atoms within the amino acid sequence are identified for labeling with ¹⁵N or ¹³C, respectively, to form an isotopically labeled peptide. In some embodiments, the isotopic labeling scheme is a ¹⁵N^{H} and ¹³C^{O} isotopic labeling scheme, wherein specific peptide backbone nitrogens and carbons are identified for labeling with ¹⁵N or ¹³C, respectively, to form an isotopic backbone labeled peptide.

In some embodiments, the methods can determine different isotopic labeling schemes by predicting an absence of an NMR cross-peak or a presence of an NMR cross-peak. The absence and the presence can be assigned to a pair of consecutive amino acids in the amino acid sequence. “Absence” of a cross-peak is intended to mean that no signal at a certain resonant frequency would be detected in an NMR spectroscopic analysis. “Presence” of a cross-peak is intended to mean that signal would be detected at a particular resonant frequency corresponding to an isotopically labeled amino acid in an NMR spectroscopic analysis. In one embodiment, the absence of the NMR cross-peak is expected where neither amino acid in the pair of consecutive amino acids is isotopically labeled. In one embodiment, the presence of one NMR cross-peak is expected where the second amino acid of the pair of amino acids is isotopically labeled. In one embodiment, the presence of two overlapping NMR cross-peaks is expected where both amino acids of the pair of amino acids are isotopically labeled.

In an example embodiment shown in FIG. 4A, a pair of amino acids can be labeled or not labeled to produce an NMR cross-peak during NMR spectroscopic analysis. Such NMR cross-peaks can be predicted by the computer algorithm described herein so as to determine an optimal set of different isotopic labeling schemes. If a pair of amino acids are not labeled, then no NMR cross-peak will be present, i.e., there is an absence of an NMR cross-peak. If the amide nitrogen of the second amino acid in the pair of amino acids is labeled, then an NMR cross-peak will be identified. In one embodiment, the [¹H-¹⁵N] cross-peak in an HSQC spectrum will appear if the second residue in a pair is ¹⁵N labeled. In some embodiments, both of the amino acids in the pair of amino acids can be isotopically labeled. In one embodiment, the amide nitrogen of the second amino acid is labeled and the C(O) carbon of the first amino acid in the pair is labeled. As shown in FIG. 4, the [¹H-¹⁵N] cross-peak in the HSQC spectrum and the [¹H-¹⁵N-¹³C] cross-peak in the HNCO spectrum will be present if the pair of amino acids or peptide group is double [¹³C-¹⁵N]-labeled. In certain embodiments, the dual ¹⁵N/¹³C combinatorial selective labeling scheme can be designed for backbone assignments of a particular amino acid sequence.

In some embodiments, the methods can determine or predict which NMR cross-peaks can be assigned to a particular amino acid pair in the sequence. As described above, the methods are designed to maximize the number of assignments of peaks to amino acids in the sequence. By using a determined combination of different isotopic labeling schemes, the methods herein can identify the number and identity of unambiguous positional assignments for at least one amino acid pair in the sequence. For example, ¹H^{N}, ¹⁵N^{H}, and/or ¹³C^{O} backbone resonances can be associated with or assigned to a specific pair of amino acids in the sequence. As recited herein, this process is described as identifying a “positionally unique peak signature” for a pair of amino acids in the amino acid sequence. As used herein, a “positionally unique peak signature” means that one or more NMR cross-peaks can be assigned to one particular amino acid pair in the sequence. By using the positionally unique peak signature, the cross peak resonance(s) are unambiguously assigned to one particular amino acid pair. The number of positionally unique peak signatures for pairs of amino acids will typically depend on the number of different isotopic labeling schemes, which in turn will determine the number of isotopically labeled peptides that are spectroscopically analyzed with NMR. More isotopic labeling schemes will typically correspond to more positionally unique peak signatures. In some embodiments, the number of different isotopic labeling schemes can be designed to unambiguously assign about 10% to about 60% of the ¹H^{N}, ¹⁵N^{H}, and/or ¹³C^{O} backbone resonances to their respective pairs of amino acids. In other words, about 10% to about 60% of the ¹H^{N}, ¹⁵N^{H}, and/or ¹³C^{O} backbone resonances would have a positionally unique peak signature. In some embodiments, the number of different isotopic labeling schemes can be designed to unambiguously assign about 20% to about 50% of the ¹H^{N}, ¹⁵N^{H}, and/or ¹³C^{O} backbone resonances to their respective pairs of amino acids (about 20% to about 50% of the ¹H^{N}, ¹⁵N^{H}, and/or ¹³C^{O} backbone resonances would have a positionally unique peak signature). In some embodiments, the number of different isotopic labeling schemes can be designed to unambiguously assign about 30% to about 40% of the ¹H^{N}, ¹⁵N^{H}, and/or ¹³C^{O} backbone resonances to their respective pairs of amino acids (about 30% to about 40% of the ¹H^{N}, ¹⁵N^{H}, and/or ¹³C^{O} backbone resonances would have a positionally unique peak signature).

For some combinations of different labeling schemes of the amino acid sequence, unambiguous peak assignments cannot be provided or determined for all of the pairs of amino acids in the amino acid sequence. In these instances, a particular NMR cross-peak may be narrowed down to a number of pairs of amino acids that is greater than two. For example, a ¹H^{N}, ¹⁵N^{H}, and/or ¹³C^{O} backbone resonance may be limited down to a number of 2-10 possible positions in the amino acid sequence. In some embodiments, a ¹H^{N}, ¹⁵N^{H}, and/or ¹³C^{O} backbone resonance may be limited to 2-6 possible positions in the amino acid sequence. In some embodiments, a ¹H^{N}, ¹⁵N^{H}, and/or ¹³C^{O} backbone resonance may be limited to a number of 2-4 possible positions in the amino acid sequence. In some embodiments, a ¹H^{N}, ¹⁵N^{H}, and/or ¹³C^{O} backbone resonance may be limited to a number of 2 possible positions in the amino acid sequence. As recited herein, a “structurally unique peak signature” refers to NMR cross-peaks that can be assigned to at least two amino acid pairs along the structure of the amino acid sequence. In some embodiments, the structurally unique peak signature identifies amino acid pairs having the same structural side chains (e.g., two or more valine-leucine amino acid pairs within the amino acid sequence). This is in contrast to the “positionally unique peak signature” above, which refers to NMR cross-peaks that can be assigned to one specific amino acid pair in the amino acid sequence. In some embodiments, the methods described herein can determine a structurally unique peak signature for at least two pairs of amino acids in the amino acid sequence, e.g., backbone resonance cross-peaks can be corresponded to two pairs of amino acids, three pairs of amino acids, and/or four pairs of amino acids. In some embodiments, a structurally unique peak signature can be determined for two pairs of amino acids. In some embodiments, a structurally unique peak signature can be determined for three pairs of amino acids. In some embodiments, a structurally unique peak signature can be determined for four pairs of amino acids. The structurally unique peak signatures, i.e., assignment of peaks to a limited number of amino acid pairs, can be used to reduce data analysis time and thereby improve speeds for determining structurally information (e.g., three dimensional structural information) for the amino acid sequence.

In some embodiments, a unique tag can be assigned to each pair of amino acids in the amino acid sequence based on the absence or the presence of a predicted or detected NMR cross-peak. These tags can be used to facilitate assignment of the backbone resonances with amino acids in the amino acid sequence. In some embodiments, unique tag identifiers can be associated with or assigned to a pair of amino acids. A unique tag identifier may be used to indicate whether a particular amino acid pair shows an absence of an NMR cross-peak, the presence of a single NMR cross-peak (e.g., an HSQC spectrum), or the presence of a cross-peak in two overlapping spectra (e.g., a peak present in an HSQC spectrum and a peak present in a HCNO spectrum). Any appropriate symbols may be used for the unique tag identifiers (e.g., numbers, letters, Greek symbols, etc.). In some embodiments, numbers may be used thereby providing a unique tag of, for example, “0,” “1,” or “2” that can be associated with or assigned to a pair of amino acids. In one embodiment, absence of a cross-peak can be assigned a tag “0”. In such an embodiment, the pair of amino acids are not isotopically labeled. In other instances, one or two overlapping cross-peaks can result or be predicted to result from an isotopically labeled pair of amino acids. In one embodiment, a cross-peak present in an NMR spectrum, e.g., an HSQC spectrum, can be assigned a tag “1”. In one embodiment, a tag of “2” can be assigned for a cross-peak present in two overlapping NMR spectra, e.g., a peak present in an HSQC spectrum and a peak present in a HCNO spectrum.

In certain embodiments, a plurality of unique tags can be assigned to each pair of amino acids in the amino acid sequence based on the presence or absence of NMR cross peaks in each isotopic labeling scheme. The plurality of unique tags forms or is used to produce a unique tag code for identifying each pair of amino acids in the amino acid sequence. Thus, the unique tag code is a collection of unique tags for a given pair of amino acids corresponding to each isotopic labeling scheme. In an example embodiment shown in FIG. 4C, each cross peak labeled A, B and C correspond to a pair of amino acids present in the amino acid sequence. Based on the different isotopic labeling schemes, shown e.g., in FIG. 4B, the A, B and C cross-peaks are assigned a unique tag for each of the isotopic labeling schemes. In FIG. 4B, there are six isotopic labeling schemes, therefore the tag code for A will correspond a plurality of six unique tag codes. As shown, A will have a tag code of (011101), B will have a tag code of (021102), and C will have a tag code of (101210). These tag codes can be used to identify a pair of amino acids in an NMR spectrum, and in some instances, where an amino acid is present in the amino acid sequence being analyzed by an NMR spectroscopic analysis. The tag code predicted by the methods described herein will be identical to the tag code derived from the recorded NMR spectra and can be used to define a pair of amino acids for corresponding ¹H^{N}, ¹⁵N^{H}, and/or ¹³C^{O} backbone resonances. In some embodiments, this tag code can be used to unambiguously assign peaks to a specific type of amino acid at a specific position in the amino acid sequence. Such identification allows for production of structural information (e.g., three-dimensional structural information) of the amino acid sequence.

As described herein, the methods can further include providing data to a user. Such data can include information that identifies, corresponds to, and/or includes different isotopic labeling schemes of an amino acid sequence. The data can be provided by a variety of different ways that will be appreciated by one of ordinary skill in the art. For example, data identifying the different isotopic labeling schemes can be presented on a computer screen, or output to another type of visualization device. In some embodiments, the data can be provided as a table identifying isotopic labels for each amino acid in the different isotopic labeling schemes for the amino acid sequence. As shown, for example, in FIG. 4B, each amino acid of an amino acid sequence can be provided along with the labeling scheme for each different isotopic labeling scheme for the amino acid sequence. In some embodiments, the data identifies a positionally unique peak signature for an amino acid in the amino acid sequence. In some embodiments, the data identifies a structurally unique peak signature for at least two pairs of amino acids in the amino acid sequence.

### III. Computer-Readable Storage Media and Systems

In yet another aspect, a computer-readable storage medium is provided for determining a plurality of different isotopic labeling schemes. The computer-readable storage medium has stored thereon instructions that, when executed by one or more processors of a computer system, cause the computer system to at least receive a user input specifying an amino acid sequence and an integer representing a number of different isotopic labeling schemes for the amino acid sequence. The computer system also can determine each of the number of different isotopic labeling schemes for the amino acid sequence. The computer system further provides data to a user. The data provided to the user can include identification of each of the number of different isotopic labeling schemes for the amino acid sequence.

In yet another aspect, a system is provided for determining a plurality of different isotopic labeling schemes. The system includes one or more processors, and memory including instructions executable by the one or more processors. When the instructions are executed by the one or more processors, the system at least receives a user input specifying an amino acid sequence and an integer representing a number of different isotopic labeling schemes for the amino acid sequence. The system further determines each of the number of different isotopic labeling schemes for the amino acid sequence. The system also provides data to a user. The data provided to the user can include identification of each of the number of different isotopic labeling schemes for the amino acid sequence.

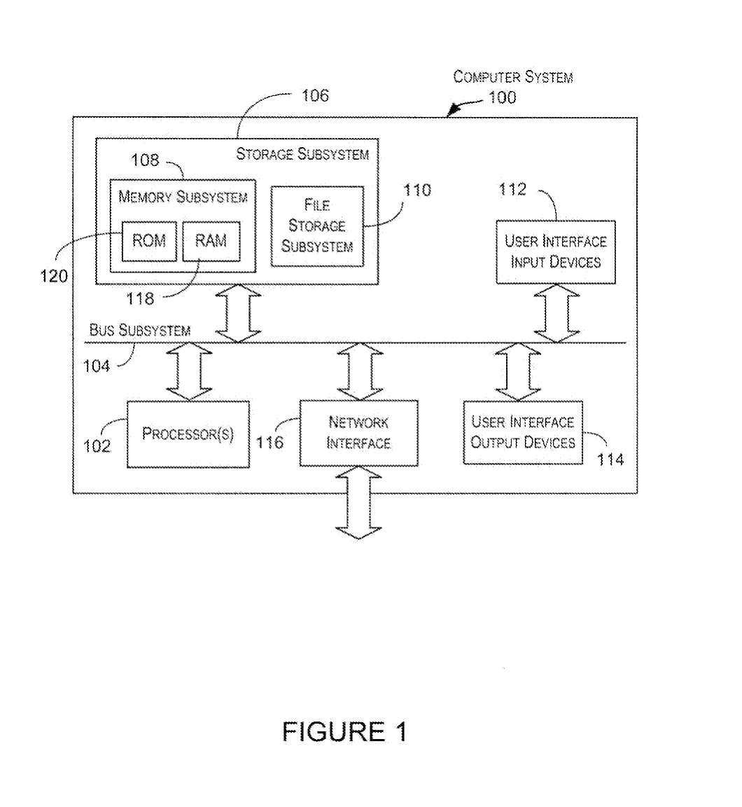

FIG. 1 is a simplified block diagram of a computer system 100 that may be used for the methods, media and systems described herein. In various embodiments, computer system 100 may be used to implement any of the systems or methods illustrated and described above. As shown in FIG. 1, computer system 100 includes a processor 102 that communicates with a number of peripheral subsystems via a bus subsystem 104. These peripheral subsystems may include a storage subsystem 106, comprising a memory subsystem 108 and a file storage subsystem 110, user interface input devices 112, user interface output devices 114, and a network interface subsystem 116.

Bus subsystem 104 provides a mechanism for enabling the various components and subsystems of computer system 100 to communicate with each other as intended. Although bus subsystem 104 is shown schematically as a single bus, alternative embodiments of the bus subsystem may utilize multiple busses.

Network interface subsystem 116 provides an interface to other computer systems and networks. Network interface subsystem 116 serves as an interface for receiving data from and transmitting data to other systems from computer system 100. For example, network interface subsystem 116 may enable a user computer to connect to the Internet and facilitate communications using the Internet.

User interface input devices 112 may include a keyboard, pointing devices such as a mouse, trackball, touchpad, or graphics tablet, a scanner, a barcode scanner, a touch screen incorporated into the display, audio input devices such as voice recognition systems, microphones, and other types of input devices. In general, use of the term “input device” is intended to include all possible types of devices and mechanisms for inputting information to computer system 100.

User interface output devices 114 may include a display subsystem, a printer, a fax machine, or non-visual displays such as audio output devices, etc. The display subsystem may be a cathode ray tube (CRT), a flat-panel device such as a liquid crystal display (LCD), or a projection device. In general, use of the term “output device” is intended to include all possible types of devices and mechanisms for outputting information from computer system 100. An advertisement may be output by computer system 100 using one or more of user interface output devices 114.

Storage subsystem 106 provides a computer-readable storage medium for storing the basic programming and data constructs. Software (programs, code modules, instructions) that when executed by a processor provide the functionality of the methods and systems described herein may be stored in storage subsystem 106. These software modules or instructions may be executed by processor(s) 102. Storage subsystem 106 may also provide a repository for storing data used in accordance with the present invention. Storage subsystem 106 may include memory subsystem 108 and file/disk storage subsystem 110.

Memory subsystem 108 may include a number of memories including a main random access memory (RAM) 118 for storage of instructions and data during program execution and a read only memory (ROM) 120 in which fixed instructions are stored. File storage subsystem 110 provides a non-transitory persistent (non-volatile) storage for program and data files, and may include a hard disk drive, a floppy disk drive along with associated removable media, a Compact Disk Read Only Memory (CD-ROM) drive, an optical drive, removable media cartridges, and other like storage media.

Computer system 100 can be of various types including a personal computer, a portable computer, a workstation, a network computer, a mainframe, a kiosk, a server or any other data processing system. Due to the ever-changing nature of computers and networks, the description of computer system 100 depicted in FIG. 1 is intended only as a specific example for purposes of illustrating the preferred embodiment of the computer system. Many other configurations having more or fewer components than the system depicted in FIG. 1 are possible.

### IV. Examples

### Example 1

The following examples are provided to illustrate certain embodiments of the invention and are not intended to limit the scope of the invention.

### A. Results and Discussion

NMR structural studies of integral membrane proteins (IMP) are hampered by complications in IMP expression, technical difficulties associated with the slow process of NMR spectral peak assignment, and limited distance information obtainable for transmembrane helices. These and other shortcomings have been addressed by, inter alia, developing a strategy which combines cell-free (CF) synthesis of IMP, nearly-instant assignment of backbone atom resonances using combinatorially dual-isotope-labeled samples, and long distance information from paramagnetic labeling. Three novel backbone structures of membrane domains of the three classes of E. coli histidine kinase receptors are provided, which are the first IMP structures from samples prepared by CF synthesis. Determined within months, they demonstrate the efficiency of our CF combinatorial dual-labeling (CDL) strategy and validate the CF expression system for IMPs.

Provided herein, inter alia, is a strategy which combines the advantages of cell free (CF) synthesis with fast heteronuclear NMR analysis and addresses the aforementioned technical difficulties hampering progress in structural studies of IMPs by NMR. CF synthesis has been successfully used for preparative scale expression of functional membrane proteins, including small multi-drug transporters, β barrel type nucleoside transporters, and G-protein-coupled receptors, for structural studies by NMR. See e.g., Klammt, C. et al., Methods Mol. Biol., 2007, 375:57; Klammt, C. et al., Febs J., September 2006, 273:4141. The complete control of the amino acid pool afforded by the CF system permits cost effective and very selective isotopic labeling possibilities for NMR analysis, including combinatorial labeling approaches (reviewed in (Ozawa, K. et al., Febs J., September 2006, 273:4154; Sobhanifar, S. et al., J Biomol NMR, Aug. 13, 2009), and thus enables fast and straightforward backbone resonance assignment and spin label-based PRE analysis. Several samples are prepared simultaneously by the CF synthesis with different combinations of ¹⁵N and ¹³C labeled amino acids and are analyzed by two short and sensitive 2D heteronuclear NMR experiments, which do not require any additional magnetization transfer to the side-chain atoms in order to obtain residue type and sequence information. The results of combinatorial backbone resonance assignment complimented with traditional sequential assignment (Wüthrich, K. NMR OF PROTEINS AND NUCLEIC ACIDS (Wiley, New York, 1986), pp. xv, 292; Clore, G. M. et al., Methods Enzymol 239:349 (1994)) are then used to obtain the structural NMR data, including torsion angles derived from the ¹³C chemical shifts, and distances derived from nuclear Overhauser effect (NOE) and the spin label-based PRE experiments, both needed to determine the 3D fold.

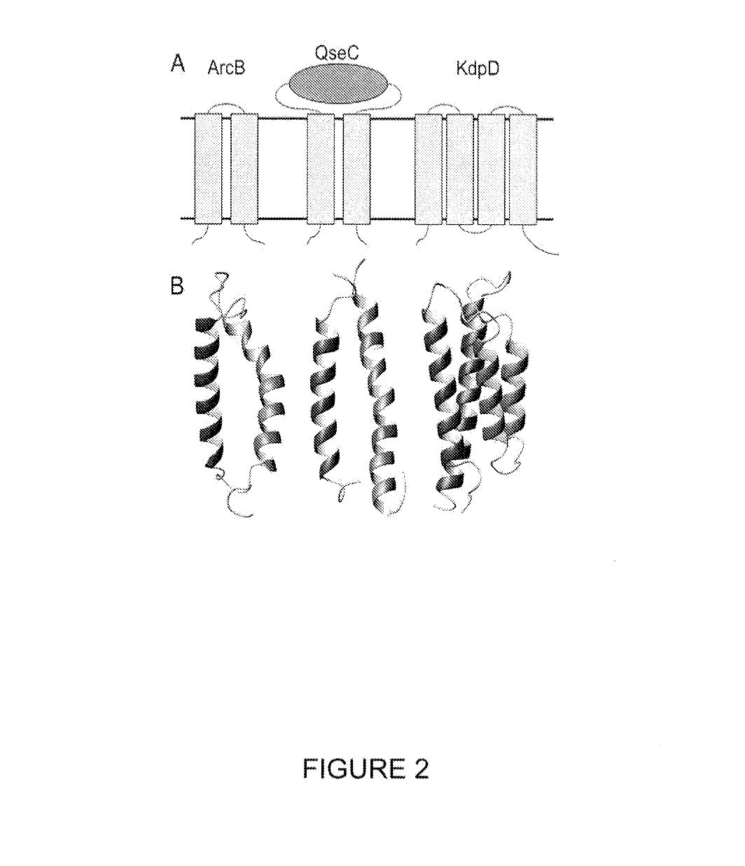

This strategy was applied to solve the structures of membrane domains of three E. coli histidine kinases receptors (HKR): aerobic respiratory control sensor (ArcB) (SEQ ID NO:1), K+ sensor (KdpD) (SEQ ID NO:2), and quorum sensor (QseC) (SEQ ID NO:3). HKRs are part of a two-component system (TCS), which includes of HKR located in the cell membrane and a response regulator (RR) located in the cytoplasm. See e.g., Wolanin, P. M. et al., Genome Biol., Sep. 25, 2002, 3:REVIEWS3013. HKR is a highly flexible multi-domain protein. This signaling system constitutes the predominant signal transduction mechanism by which bacteria interact with their environment (Wolanin, P. M. et al., Id.). Based on the way HKRs sense environmental stimuli, they are classified into three major structural groups. ArcB, KdpD, and QseC have been selected to represent these groups in this study. The largest group is characterized by the presence of an extracytoplasmic sensory domain that responds to external stimuli by transmitting the signal across the membrane (QseC). The second group lacks an apparent extracytoplasmic domain and the stimuli-sensing region is believed to be in the membrane domain itself (ArcB). The third group is characterized by a cytoplasmic sensory domain (KdpD). These representatives also possess diverse structures of their membrane domains (FIG. 2): QseC has two TM helices connected by a 130-amino acid periplasmic sensor domain, ArcB has two TM helices and a very short periplasmic loop, and KdpD has four TM helices with short interhelical loops. The large cytoplasmic C-terminal kinase domain of HKRs is divided into several subdomains, including a dimerization domain containing the conserved histidine and a catalytic ATP-binding domain. Several structures of the kinase domain, including that of QseC, as well as structures of the periplasmic sensor domain, have been reported, but there is still no structure of full-length HKR, which is essential to understand the mechanistic aspect of signal transduction.

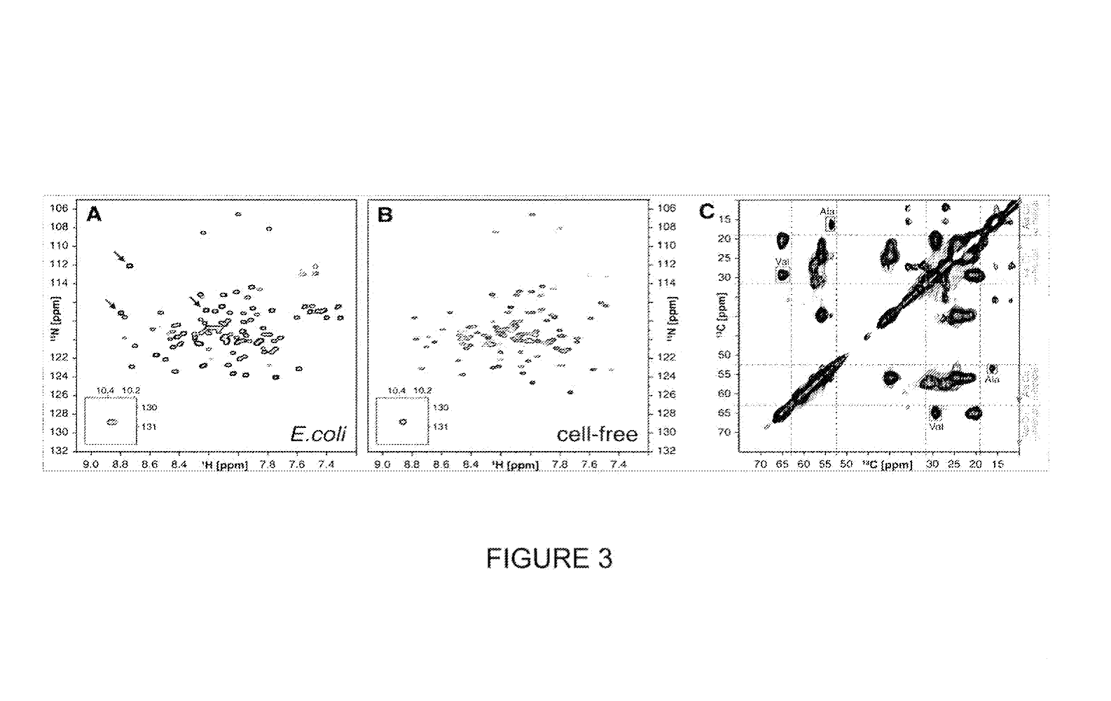

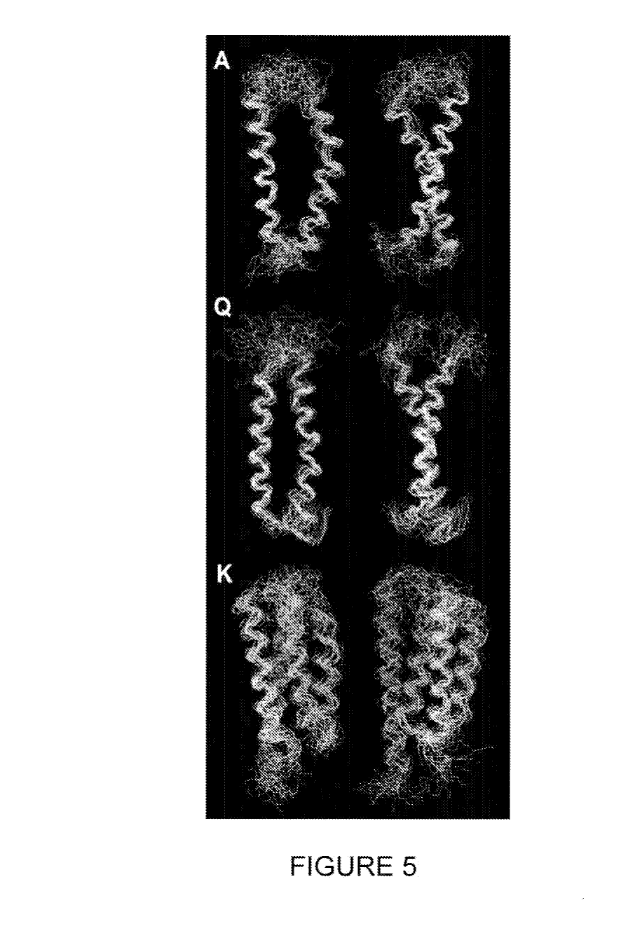

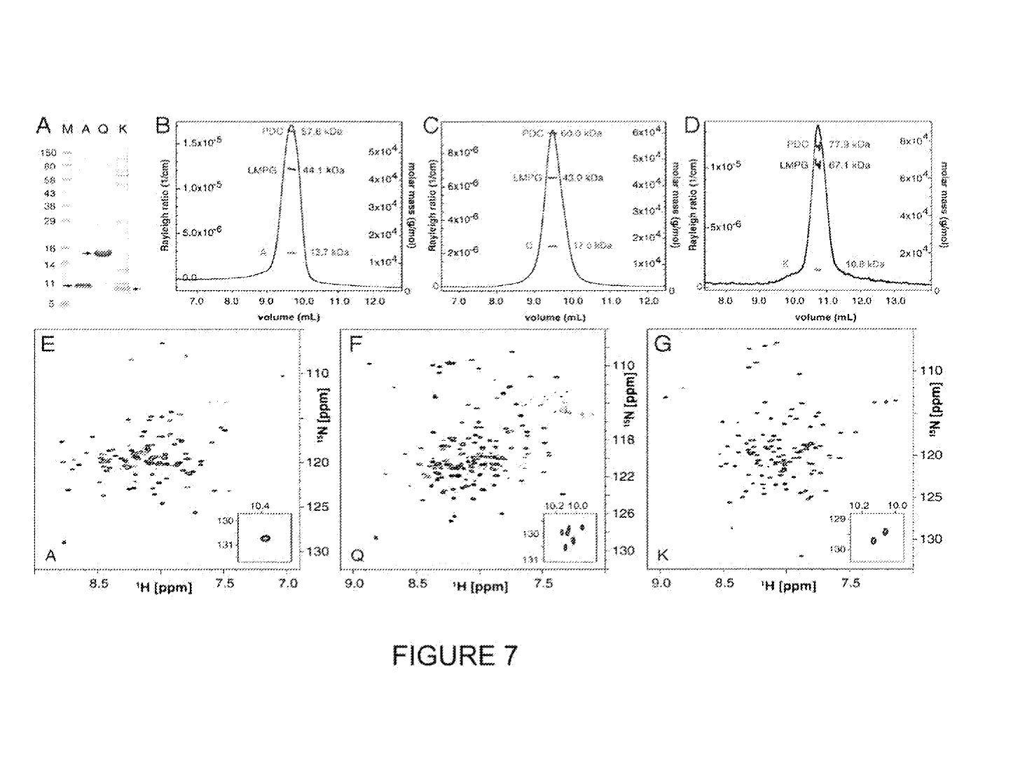

To synthesize membrane domains of selected histidine kinases, the precipitating CF (p-CF) expression mode (Klammt, C. et al., Eur J Biochem, February 2004, 271:568) was used, in which a protein is produced as a precipitate and is subsequently solubilized by a non-denaturing detergent. The p-CF mode is extremely useful. It allows NMR studies of membrane proteins without purification since all of the CF reaction components are soluble: they remain in a supernatant, and are easily removable after reaction by pellet wash. As a result, the target membrane protein can be expressed without any tags, which might affect its spatial structure or stability. The prevailing view on the state of IMPs in the CF precipitant is that it resembles that of an inclusion body, which is a large insoluble protein aggregate. However, solubilization of an inclusion body protein requires complete unfolding by a strong denaturing compound. See e.g., Baneyx, F. et al., Nat. Biotechnol., November 2004, 22:1399. In contrast, CF precipitant can be solubilized with a mild lipid-like detergent. See e.g., Klammt, C. et al., Eur J Biochem., February 2004, 271:568. Therefore, it is believed that the CF precipitant must have an already partially pre-folded secondary structure. To support this view MAS-NMR measurements were performed directly on the precipitant of the p-CF expression of uniformly ¹³C-labeled ArcB(1-115) and KdpD(397-502). All visible ¹³C^{α}-¹³C^{β} cross peaks for alanine and valine residues lay in the regions of the ¹³C-¹³C correlation spectra typical for the helical conformation (Wishart, D. S. et al., J Biomol NMR, March 1994, 4:171) and none is in the random coil area (FIGS. 2 and 5). Moreover, the MAS-NMR spectrum of the ArcB(1-115) precipitant is very similar to the spectrum of the ArcB(1-115) sample, lyophilized after solubilization with a detergent (FIG. 3C, contours). Secondary structure analysis by solution NMR shows that in ArcB(1-115) 11 out of 16 valines and 5 out of 7 alanines are located in TM helical regions. The ¹³C^{α}-¹³C^{β} cross-peaks for valine and alanine residues situated in unordered loop regions are probably broadened beyond detectability limits in the MAS-NMR spectra. Solid state NMR analysis of chemical shifts together with solution NMR data on exchange of the labile backbone protons in the precipitant (FIG. 7) have unambiguous interpretation: the TM helices of TM-ArcB and TM-KdpD were pre-folded as secondary structure elements before precipitation in a CF reaction.

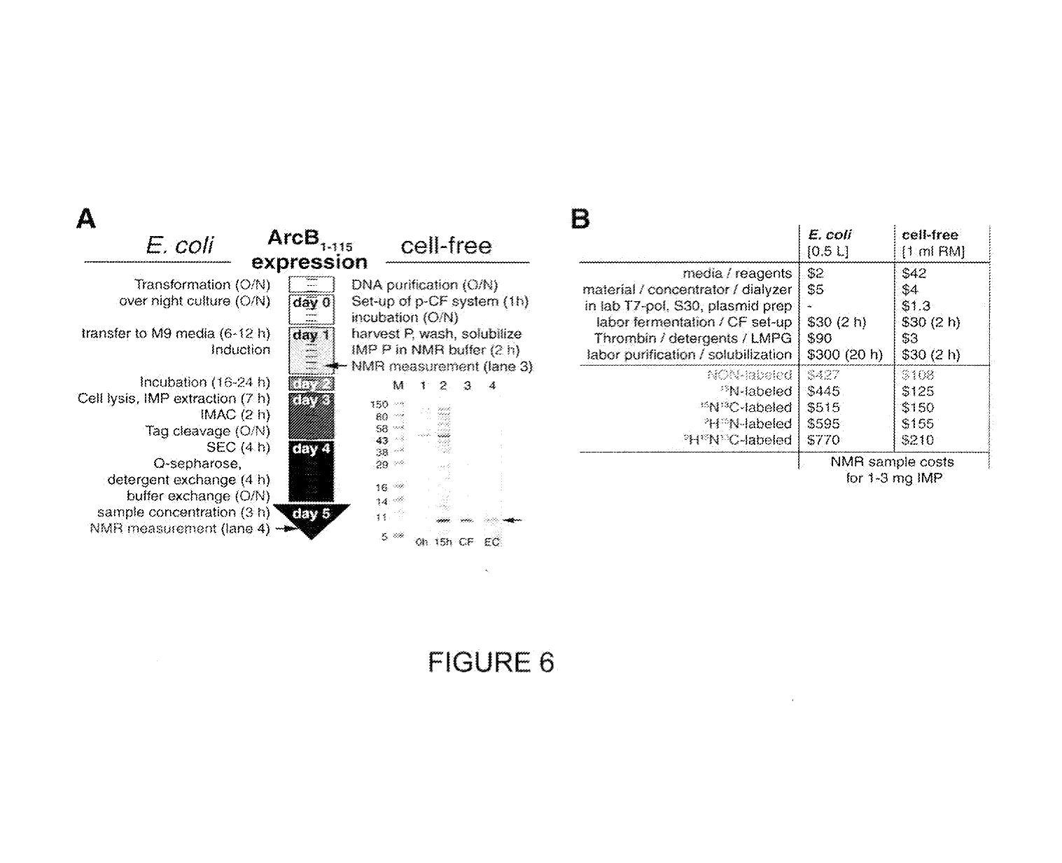

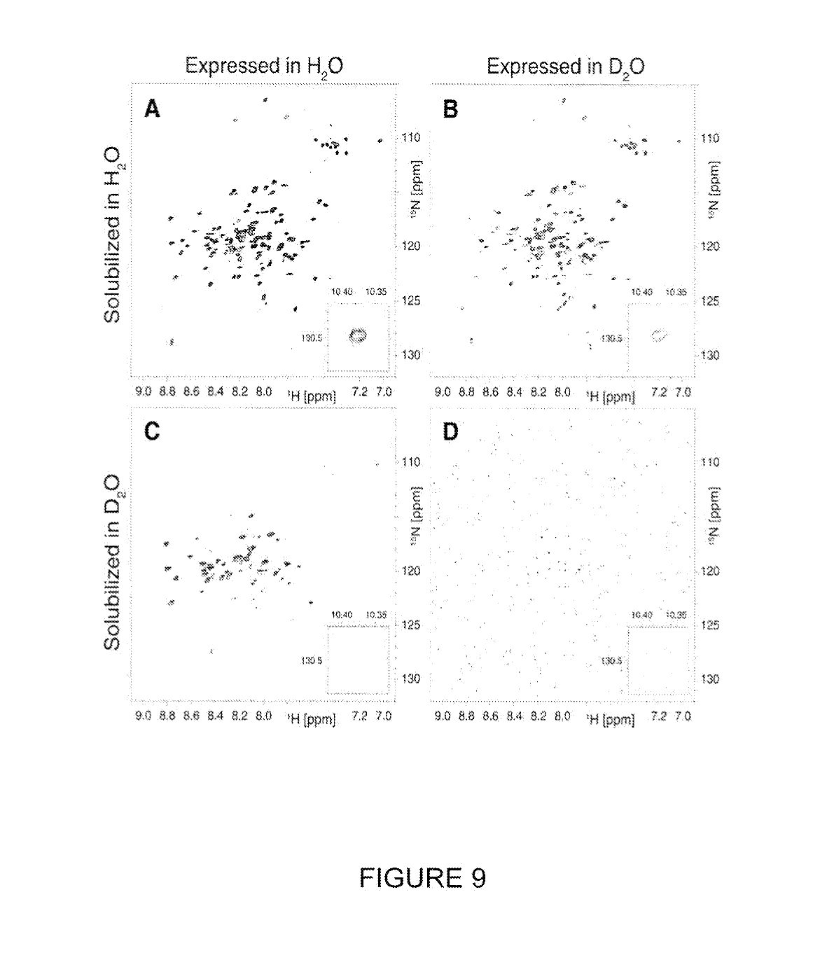

To further validate the p-CF expression system, p-CF synthesis was compared with the standard E. coli system regarding sample quality, protein fold, as well as time and cost efficiency (FIG. 6). It is understood that an N-terminal Met residue can be included in polypeptides expressed in cell-free systems. The ArcB(1-115) TM domain of E. coli histidine kinase was expressed and purified using both approaches. With the E. coli system, it takes 5 consecutive days, beginning with the transformation and growing of bacteria in minimal media and then extracting and purifying the protein from cell membrane, to obtain the first NMR measurement data of the expressed protein. In contrast, the CF synthesis made the first NMR measurement possible the next day, after overnight expression and solubilization of the protein. The comparison of both [¹H-¹⁵N]-TROSY-HSQC spectra obtained from protein produced by the E. coli (FIG. 3A) and the CF expression systems (FIG. 3B) shows that the positions of all backbone cross-peaks are nearly identical. The difference in the number of the cross peaks results from slightly different constructs used for each expression (one with a tag and the other without). The collected backbone NOE data and ¹³C^{α} chemical shift index (FIG. 9) are also very similar for both samples. Taken together, these results lead us to conclude that structural folds of the ArcB(1-115) prepared using the CF and the E. coli expression systems are the same.

Sequential assignment of backbone resonances for NMR de novo structure determination is a laborious process for α-helical IMPs mainly because of very strong signal overlapping caused by narrow chemical shift dispersion and line broadening due to slow overall mobility of the IMP-detergent complex and intrinsic internal flexibility of the TM helices. To speed up the assignment process in a case of complicated and crowded spectra, several selective and combinatorial labeling approaches were developed (reviewed recently in Ozawa, K. et al., Febs J., September 2006, 273:4154; Sobhanifar, S. et al., J Biomol NMR, Aug. 13, 2009). The simplest approach, relying on selective ¹⁵N labeling, allows defining of the type of amino acid for every [¹H-¹⁵N] cross peak. The number of selectively labeled samples depends on the chosen strategy, protein amino acid content, and complexity of the spectra, but, in general, 5 combinatorially ¹⁵N-labeled samples (with two possible choices for each amino acid: labeled or non-labeled) with one [¹H-¹⁵N]-HSQC experiment per sample are sufficient to identify the type of 19 non-proline amino acid for each ¹H-¹⁵N cross peak for any protein (Wu, P. S. et al., J Biomol NMR, January 2006, 34:13).

The general idea of using selective ¹⁵N and ¹³C labeling for assignment of [¹H-¹⁵N] cross peaks to a specific residue in a protein sequence is based on the fact that labeling of both ¹³C^{O} and ¹⁵N^{H} atoms of a particular peptide bond gives rise to a cross peak in both HSQC and HNCO spectra. Therefore, the amino acids forming the peptide bond can then be defined for the ¹H^{N}, ¹⁵N^{H}, and ¹³C^{O} resonances giving the cross peaks (FIG. 4A). If a pair of the amino acids involved in the peptide bond is unique in a given protein sequence, the assignment of the ¹H^{N} and ¹⁵N^{H} resonances to the second residue, as well as the assignment of the ¹³C^{O} resonance to the first residue of the pair, is instantly made. If the pair is not unique, amino acid types and a few (usually 2-4) possible positions in the protein sequence can still be identified for the resonances associated with the pair.

The challenge is to combine ¹⁵N and ¹³C combinatorial labeling in such a way that using a minimal number of samples we could still define the type of the preceding and the following amino acid for all pairs and thus assign ¹H-¹⁵N cross peaks for all unique pairs in the sequence. Unlike the combinatorial approach with mixed (100% ¹⁵N/¹³C and 50% ¹⁵N) labeling (see e.g., Parker, M. J. et al., J Am Chem. Soc., Apr. 28, 2004, 126:5020), which uses the differences in cross peak intensities easily affected by factors like different mobility of the IMP TM domains, we used information about both the presence and the absence of cross peaks in [¹H-¹⁵N]-HSQC and HNCO spectra, thus, expands the method proposed in (Trbovic, N. et al., J Am Chem. Soc., Oct. 5, 2005, 127:13504). The key advantage of the CF combinatorial dual-labeling (CDL) strategy is that it allows us to use a minimal number of samples and ensures minimal complexity of the spectra, which is essential for rapid peak assignments. While other existing combinatorial labeling designs are universal (see e.g., Wu, P. S. et al., J Biomol NMR, January 2006, 34:13; Parker, M. J. et al., J Am Chem. Soc., Apr. 28, 2004, 126:5020), in order to achieve maximal efficiency the CDL strategy presumes a unique combinatorial labeling scheme for every protein sequence. To derive these schemes, we have developed a program (MCCL). MCCL calculates the optimal labeling combination for a given protein sequence with a defined number of samples using the Monte Carlo approach. It is noteworthy that the combinatorial selective isotope-labeling approach of the CDL strategy is technically feasible only because of the in vitro CF expression system (Sobhanifar, S. et al., J Biomol NMR, Aug. 13, 2009). The selective labeling in in vivo expression systems is ineffective because amino acid synthetic pathways frequently overlap. See e.g., McIntosh, L. P. et al., Rev Biophys., February 1990, 23:1.

This CDL strategy was further refined during the design of combinatorial [¹⁵N, ¹³C]-labeling schemes for both KdpD(397-502) (FIG. 4C) and QseC(1-185), which consisted of 6 and 7 labeled samples, respectively. This allowed us to unambiguously assign 29 ¹H-¹⁵N cross-peaks for KdpD(397-502) and 41 ¹H-¹⁵N cross-peaks for QseC(1-185) within one day after spectra collection. The type of an amino acid was defined for 100% and 74% of the ¹H-¹⁵N cross-peaks for KdpD(396-502) and QseC(1-185), respectively. Starting from and building upon the results of the CDL-derived assignment, the standard sequential assignment procedure was tremendously accelerated. See e.g., Wüthrich, K. NMR of proteins and nucleic acids (Wiley, New York, 1986), pp. xv, 292; Clore, G. M. et al., Methods Enzymol., 1994, 239:349. Finally, 100% of KdpD(397-502) and 76% of QseC(1-185) backbone resonances were assigned. ArcB(1-115) resonances (96% of the backbone, 88% of C^{β}, and most of H^{α} and H^{β}) were assigned using the standard sequential assignment protocol.

The assignment of backbone resonances enabled us to proceed with de novo NMR structure determination. We used the ¹³C^{α} chemical shift deviation from random coil values to define backbone torsion angle restraints (Luginbuhl, P. et al., J. Magn. Reson. B., 1995, 109:229), ¹H-¹H NOEs to define sequential distance constraints, and PRE analysis to derive long-range distance constraints (Roosild, T. P. et al., Science, Feb. 25, 2005, 307:1317). Structure calculation was performed with the CYANA program (Guntert, P. Methods Mol. Biol., 2004, 278:353). The analysis of helical packing parameters, such as inter-helical crossing angles, inter-helical distances, and helical kinks in the determined backbone structures, was subsequently conducted with the Helix Packing Pair program. See e.g., Dalton, J. A. et al., Bioinformatics, Jul. 1, 2003, 19:1298.

The resulting structures of ArcB(1-115) and QseC(1-185) (FIGS. 1B and 4) represent two-helical hairpins with the expected length of bilayer-crossing helices. With a large periplasmic signaling domain, the TM domain of QseC is composed of two anti-parallel (crossing angle of 157±4°) non-interacting α-helices, allowing the flexibility needed for the conformational change to transduce the signal across the membrane. The TM domain of ArcB includes two α-helices with the crossing angle of 142±6.5° and the minimal distance of 11.1 Å between the helices. In comparison, the crossing angle between two helices of HTR-II Transducer in complex with sensory Rhodopsin (Gordeliy, V. I. et al., Nature, Oct. 3, 2002, 419:484) is 169° and the distance between the helices is 10 Å, while for two tightly interacting helices in dimeric human glycophorin A the distance is just 6.4 Å (MacKenzie, K. R. et al., Science, Apr. 4, 1997, 276:131). Prolines at position 67 of ArcB and positions 166 and 173 in QseC disrupt helical hydrogen bond patterns and create kinks of 22±2° (ArcB(1-115)), 22±5° and 24±4° (Qsec(1-185)) in the second helix, which add local flexibility to the helices and increase inter-helical distances near the periplasmic side of the membrane, thus additionally weakening the helix-helix interactions. The TM domain of KdpD includes four-helical bundles (FIGS. 1B and 4), in which the second and the third helix are relatively short (15 residues) and loosely packed with the crossing angle of −165±6° and the interhelical distance of ˜9.4 Å. The second helix interacts mostly with the third one. The first and the forth helix show the crossing angle of −157±4°. These two helices weakly interact only near their cytoplasmic ends and this is the only consistent interaction involving the first helix, which causes the whole bundle to be packed rather loosely.

The packing of TM α-helices is related to protein function and could be rigid, as observed in the case of channel pores like KcsA (Zhou, Y. et al., Nature, Nov. 1, 2001, 414:43), ionotropic receptors like nAChR (Unwin, N. J Mol Biol., Mar. 4, 2005, 346:967), Glutamate receptor channel (Sobolevsky, A. et al., Nature, Dec. 10, 2009, 462:745), and tightly packed multi-helical proteins like membrane respiratory enzymes (Wittig, I. et al., Biochim Biophys Acta, June 2009, 1787:672), or flexible, as observed in the case of many metabotropic membrane receptors like GPCRs (Cherezov, V. et al., Science, Nov. 23, 2007, 318:1258) and kinase receptors. The majority of the solved structures of the IMPs (>97%) represent proteins which actively or passively transport a physical object like molecule, ion, proton, or electron across the biological membrane (channels and transporters) or tightly bind another molecule for enzymatic reaction (oxidases, ATPases, intramembrane proteases, etc.). The metabotropic membrane receptors are still a much underrepresented family in the Protein Data Bank. Their primary role in a cell is to transmit signals through the membrane. Therefore, they do not require a well defined conformational state of the TM domain, needed, for example, for coordinating transported ions or molecules. In order to transmit a signal they need a global conformational switch of the TM domain, provided mostly by the intrinsic mobility of the helical TM domain (Hendrickson, W. A. Q Rev Biophys., November 2005, 38:321). The flexible packing of the TM core can be one of the reasons why these multi-domain proteins elude crystallization.

Three structures presented in this study offer a glimpse into the abundant class of 2-4 TM crossers, which are also underrepresented in the Protein Data Bank (PDB) and provide an important inroad towards understanding the mechanistic aspects of the presumably conformation-driven signal transduction process. The CDL strategy grounded in the synergy between the CF and the NMR methods which we employed in this study opens up new possibilities for fast determination of backbone structures of membrane proteins, especially those recalcitrant to crystallization. Backbone structures determined quickly by the CDL strategy would provide excellent starting points for high-throughput modeling of a large number of classes of IMPs and further structure-function prediction.

### B. ArcB(1-115) E. coli Expression and NMR Sample Preparation

An ArcB fragment comprising residues 1-115 was cloned into a Gateway-adapted pHis vector (Kefala, G. et al., J Struct Funct Genomics, December 2007, 8:167), resulting in a construct with a thrombin-cleavable N-terminal His9 tag: MKHHHHHHHHHGGLESTSLYKKAGSLVPRGSGS (SEQ ID NO:4), and expressed in E. coli BL21 DE3 cells (Invitrogen, Calif., USA). Cells obtained from overnight cultures were transferred into a M9 minimal medium and grown at 37° C. The M9 medium was supplemented with 2 g/L ¹⁵NH₄Cl and 4 g/L Glucose for a uniformly ¹⁵N-labeled sample. For ¹⁵N-¹³C- or 2H-¹⁵N-¹³C-labeled samples ¹³C-Glucose or 2H-¹³C-Glucose in 99.9% D₂O was used, respectively. Protein expression was induced with 0.5 mM IPTG at OD₆₀₀=1, followed by incubation at 18° C. for 16-20 hours. Cells were harvested by centrifugation, resuspended in a lysis buffer (20 mM Tris-HCl, pH 8.0, 0.5 mM EDTA) and lysed in M-100L CF microfluidizer (Microfluidics, Mass., USA). The pellet from centrifugation (45,000 g, 2 h) was suspended in a solubilization buffer (20 mM Tris-HCl, pH 8.0, 200 mM NaCl, 18 mM FC12, 4 mM BMe) for membrane extraction and incubated with stirring for 2 h at 4° C. The extracted protein in the supernatant was separated by centrifugation (45,000 g, 2 h) and purified by Ni-NTA. In particular, 5 ml of Ni-NTA Agarose (Qiagen, Calif., USA) were equilibrated with 5 column volumes (CV) of a washing buffer (20 mM Tris-HCl, pH 8.0, 200 mM NaCl, 4 mM FC12) before loading the sample. To improve protein binding to Nickel, the beads and the sample were incubated with shaking at 4° C. for 15-20 min. The beads were washed with 8 CV of the wash buffer before elution with 3 CV of an elution buffer (20 mM Tris-HCl, pH 8.0, 200 mM NaCl, 4 mM FC12, 3 mM BMe, 300 mM Imidazole). For cleaving of the N-terminal tag, elution fractions were concentrated to 2.5 ml in 10 kDa MWCO Vivaspin 20 (Sartorius Stedim Biotech GmbH, Germany), desalted in 20 mM Tris-HCl, pH 8.0, 200 mM FC12, 2 mM CaCl₂ using a PD-10 column (GE Healthcare Bio-Sciences Corp, N.J., USA), and cleaved with 10U Thrombin/1 mg protein (Sigma-Aldrich, Mo., USA) overnight at room temperature (RT). The cleaved His9-tag was removed by incubating the sample with 2 ml of Ni-NTA Agarose, equilibrated with an FPLC buffer (20 mM Tris-HCl, pH 8.0, 200 mM NaCl, 2 mM FC-12, 1 mM DTT) shaken for 15 min at 4° C., followed by elution with 2 CV of the FPLC buffer. Ni-NTA flowthrough was concentrated to 2 ml and purified by size exclusion FPLC on a 16/60 Superdex™ 200 column (GE Healthcare Bio-Sciences Corp, N.J., USA) equilibrated in the FPLC buffer. To exchange FC-12 with LMPG, FPLC fractions corresponding to the monomer were concentrated and their pH was changed with 20 mM Tris-HCl, pH 9.0, 1 mM DTT in a 10 kDa MWCO Vivaspin 20 before loading on 2 ml of Q-Sepharose® resin (GE Healthcare Bio-Sciences Corp, N.J., USA) at RT, equilibrated with 20 CV 20 mM Tris-HCl, pH 9.0, 0.2 mM LMPG. Bound protein was washed with 20 CV 20 mM Tris-HCl, pH 9.0, 4 mM LMPG before high salt elution with 30 CV 20 mM Tris-HCl, pH 9.0, 0.5 M NaCl, 1 mM LMPG. For NMR sample preparation, the eluted protein was concentrated and desalted and the sample pH was changed by concentration and washing with 20 mM sodium acetate pH 5.5, 10 mM NaCl, 0.2 mM LMPG using a 10 kDa MWCO Vivaspin 20 concentrator.

### C. Cloning Procedures and Protein Analysis

ArcB(1-115), QseC(1-185) and Kdpd(397-502) for cell-free expression were amplified from cDNA by standard polymerase chain reaction techniques using Vent DNA-polymerase (NEB, MA, USA). Suitable restriction sites and a c-terminal stop codon were added to the DNA fragments with suitable oligonucleotide primers. Purified PCR fragments were inserted after cleavage into pIVEX2.3 (Roche Applied Science, Ind., USA) vectors.

Cysteine residues in ArcB(1-115), QseC(1-185) and Kdpd(397-502), as well as Serine residues in KdpD(397-502) for obtaining KdpD-CS(397-502), were introduced by site directed mutagenesis at positions shown in Table 1. In particular, primers were designed as described elsewhere (2) and quick change reactions were carried out using 1 μl HotStar Polymerase (Qiagen, Calif., USA), 1× HotStar Buffer, 2% DMSO, 0.2 μM primers and 3-5 μg/ml template DNA in 50 μl reaction volume. PCR was set up in a thermocyler (Techne Inc, N.J., USA) at 95° C. for 0.5 min and cycled 18 times at 95° C. for 0.5 min, 55° C. for 100 sec, 68° C. for 10 min with the final extension time of 30 min at 68° C. Parental DNA was digested with DpnI (NEB, MA, USA) by adding 1 μl enzyme and incubation for 3 hours at 37° C., and subsequently purified by a Nucleotide purification kit (Qiagen, Calif., USA) with elution in 30 μl H₂O. 7 μl DNA was transformed into 25 μl DH10b chemical competent cells (Invitrogen, Calif., USA).

### D. CF Expression

We established a preparative high throughput E. coli-based CF expression system that has been optimized and fine-tuned for expression of integral membrane proteins (IMPs). Chemicals for CF expression were purchased from Sigma-Aldrich, stable isotope-labeled amino acids and amino acid mixtures were purchased from CIL (MA, USA) unless otherwise stated. HKRs were produced in an individual continuous exchange CF (CECF) system according to previously described protocols (Klammt, C. et al., Eur J Biochem., February 2004, 271:568; Klammt, C. et al., Methods Mol. Biol., 2007, 375:57) with further optimizations. In general, CF extracts were prepared from the E. coli strain A19 as described in (Klammt, C. et al., Eur J Biochem., February 2004, 271:568; Klammt, C. et al., Methods Mol. Biol., 2007, 375:57), T7-RNA polymerase was expressed using the pT7-911Q plasmid (Ichetovkin, I. E. et al., J Biol. Chem., Dec. 26, 1997, 272:33009) and purified as described in (Savage, D. F. et al., Protein Sci., May 2007, 16:966). Preparative scale CF reactions were performed in 20 kDa MWCO Slide-A-Lyzers (Thermo Scientific, Ill., USA) using 2 ml of reaction mixture (RM) set with the 1:17 volume ratio between RM and the feeding mixture (FM). Slide-A-Lyzers were placed in a suitable plastic box holding the FM and incubated inn a shaker (New Brunswick Scientific, N.J., USA) for approximately 15 hours at 30° C. The reaction conditions for the CF reaction were as follows. RM and FM: 270 mM potassium acetate; 14.5 mM magnesium acetate; 100 mM Hepes-KOH pH 8.0; 3.5 mM Tris-acetate pH 8.2; 0.2 mM folinic acid; 0.05% sodium azide; 2% polyethyleneglycol 8000; 2 mM Tris(2-carboxyethyl)phosphine hydrochloride (TCEP) (Thermo Scientific, Ill., USA); 1.2 mM ATP; 0.8 mM each of CTP, UTP, GTP; 20 mM acetyl phosphate (Fluka, Germany); 20 mM phosphoenol pyruvate (AppliChem GmbH, Germany); 1 tablet per 50 ml complete protease inhibitor (Roche Applied Science, Ind., USA); 1 mM each amino acid; 40 μg/ml pyruvate kinase (Roche Applied Science, Ind., USA); 500 μg/ml E. coli tRNA (Roche Applied Science, Ind., USA), 0.3 U/μl RNase Inhibitor (SUPERase-In™, Ambion, Tex., USA); 0.5 U/μl T7-RNA polymerase; 40% S30 extract and 15 μg/ml of pET21a derived plasmid DNA or 7.5 μg/ml of pIVEX2.3 derived plasmid DNA. For CF U-¹⁵N labeling, RM and FM were supplemented with 0.5 mM of ¹⁵N algal amino acid mixture and 0.5 mM of the ¹⁵N amino acids: N, C, Q, and W. For CF U-¹⁵N-¹³C, U-²H-¹⁵N and U-²H-¹⁵N-¹³C labeling, RM and FM were supplemented with 0.5 mM of correspondingly labeled amino acid mixtures. For solid state NMR measurement U-¹⁵N-¹³C-labeled samples were expressed. For combinatorial labeling of QseC(1-185) and KdpD(397-502) combinations of ¹⁵N-labeled A, C, D, E, F, G, I, K, L, M, N, Q, R, S, T, V, W, Y or 1 ¹³C labeled A, C, D, E, F, G, I, K, L, M, P, Q, S, V, W, Y, and non-labeled amino acids were used (schemes are given in Tables 2 and 3). For HRKs prepared in D₂O for D-H exchange experiments, CF expression was carried out in 99% D₂O. In particular, all chemicals where solubilized in D₂O, plasmid DNA was prepared in D₂O, and S30 extract was prepared in D₂O after growing cells in H₂O.

The performance and cost efficiency of this CF system as compared with the standard E. coli system is illustrated in FIG. 6. Cost efficiency was estimated by comparing labor ($15/hour) and material costs of producing differently uniform isotopically labeled NMR samples of ArcB(1-115) by standard E. coli and by an individual CF expression system. Contrary to the widespread belief that CF synthesis is very expensive, the comparison (FIG. 6) proved that CF expression is 3-4 times less expensive for both non-labeled and isotopically labeled proteins. In addition, CF enables the NMR sample preparation within 24 hours, compared to 5 days by E. coli expression, with the additional benefits of reproducible expression and unique labeling possibilities such as combinatorial ¹⁵N-¹³C labeling.

### E. Protein Characterization

The Invitrogen gel electrophoresis system (Invitrogen, Calif., USA) was used for all SDS-gel analyses following the manufacturer's protocol, using 12% NuPAGE® Bis-Tris Gels in Mes buffer stained with coomassie blue or InstantBlue (Expedeon Protein Solutions Ltd, UK).

The proteins were characterized by SDS-PAGE (FIG. 6A), SELDI-MS analysis (data not shown), and light scattering coupled with size exclusion chromatography and refracting index measurements (FIG. 7B-D).

### F. SEC-UV/LS/RI Analysis

The analysis of HKRs-LMPG complexes was performed by measuring the relative refractive index (RI) signal (Optilab rEX, Wyatt Technology Corporation, Calif., USA), static light scattering (LS) signals from three angles (45°, 90°, 135°) (miniDAWN™, Wyatt Technology Corporation, Calif., USA), and UV extinction at 280 nm (Waters™ 996 Photodiode Array Detector, Millipore Corporation, MA, USA) during HPLC (Waters™ 626 Pump, 600S Controller, Millipore Corporation, MA, USA) size exclusion chromatography with polymer column(Shodex® Protein KW-803). HKRs were analyzed by injecting 50 μl of 200 μM IMP solubilized in LMPG into HPLC buffer (20 mM Mes-BisTris pH 6.0, 150 mM NaCl, 0.01% LMPG) at 0.8 ml/min. The fractions, containing target proteins, were concentrated in 5 kDa MWCO Vivaspin 2 concentrators (Sartorius Stedim Biotech GmbH, Germany) to 50 μl and re-injected. The data were collected and analyzed using the Astra V 5.3.2.12 Software (Wyatt Technology Corporation, Calif., USA). The average molar weights of the protein-detergent complex, of the protein, and of the detergent fraction in the complex (FIG. 7B-D) were calculated by applying the Protein Conjugate module of the Astra program.

### G. NMR Sample Preparation

All HKRs were expressed as precipitate (p-CF) in the absence of detergents (Klammt, C. et al., Eur J Biochem., February 2004, 271:568). Precipitated recombinant proteins were removed from the RM by centrifugation at 20,000 g for 15 min and washed in two steps. First, in order to remove co-precipitated RNA, precipitates were suspended in 50% volume equal to the RM volume in 20 mM Mes-BisTris buffer pH 6.0, 0.01 mg/ml RNase A and shaken at 900 rpm and 37° C. for 30 min. After incubation, precipitates were harvested by centrifugation at 20,000 g for 10 min and suspended in 100% volume equal to the RM volume in NMR buffer (20 mM Mes-BisTris pH 5.5 for ArcB(1-115) and 20 mM Mes-BisTris pH 6.0 for QseC(1-185) and KdpD(397-502)). NMR samples were prepared from washed precipitate of 1 ml RM by solubilization in 300 μl 5% (w/v) LMPG (Avanti Polar Lipids, Ala., USA; Anatrace, Ohio, USA) in NMR buffer. The suspension was sonicated in a water bath sonicator (Bransonic, Conn., USA) for 1 minute and subsequently incubated for 15 min with shaking at 900 rpm and 37° C., followed by centrifugation at 20,000 g for 10 minutes. NMR samples were pH-adjusted, supplemented with 5% D2O and 0.5 mM 4,4-dimethyl-4-silapentane-1-sulfonic acid (DSS) and treated with 5 freeze-thaw cycles using liquid nitrogen flash freezing followed by 37° C. water bath incubation. Shigemi NMR tubes (Shigemi INC, PA, USA) were used for solution NMR measurements. “Fingerprint” spectra of the CF-expressed proteins are shown in FIGS. 6E-G. For H-D exchange experiments samples prepared in H₂O or D₂O were washed in H₂O or D₂O, respectively. H₂O and D₂O samples were solubilized in 5% LMPG in D₂O-NMR and H₂O-NMR buffers, respectively. H-D exchange samples were measured instantly after 1 min water bath sonication. For solid state NMR measurements the pellet produced in 2 ml RM was washed as described above using the same buffers and loaded into a 4 mm MAS rotor. The solid state NMR sample of ArcB(1-115) solubilized with 5% LMPG was prepared from a solution NMR sample by lyophilization.

NMR samples with single cysteine mutants (Table 1) obtained from 1 ml CF RM were prepared in 400 μl in order to measure paramagnetic relaxation enhancement (PRE) in a standard NMR tube. The samples were measured consequently before spin-labeling, spin-labeled in oxidized and in reduced states and after removing the spin label. Spin-labeling samples were supplemented with 5 mM 1-Oxyl-(2,2,5,5-tetramethyl-Δ³-pyrroline-3-methyl)methanethiosulfonate (MTSL) (Toronto Research Chemicals Inc, ON, Canada), solubilized in Acetonitrile. After overnight incubation at RT, the excess of MTSL was removed by 24 h dialysis at RT against 3×500 ml NMR buffer in Ettan™ mini dialyzers (GE Healthcare Bio-Sciences Corp, N.J., USA). Spin label was reduced with 5 mM Ascorbic Acid using a 200 mM stock solution adjusted to pH 6.5. Finally, MTSL was removed from the protein by an addition of 50 mM TCEP (Thermo Scientific, Ill., USA) and 4 h incubation at RT before overnight dialysis against 500 ml NMR buffer.

### H. NMR Experiments

Solid state NMR, 2D ¹³C-DARR, experiments (Takegoshi, K. et al., Chem. Phys. Lett., Aug. 31, 2001, 344:631-637) were performed on Bruker an AVANCE 850 spectrometer (213.765 MHz for ¹³C) using a 4 mm MAS-DVT probe at 273 K and the 14 KHz spinning rate (CBMR, Germany). 2 mg of precipitant was loaded into a 4 mm MAS rotor. The ¹H RF field strength was matched to the MAS speed during the mixing period. A DARR experiment with ArcB(1-115) was recorded using 100 ms mixing time, 256 increments of 320 scans each. The SPINAL-64 pulse with the field strength of 62.5 KHz was applied during acquisition. A DARR experiment with KdpD(397-502) was recorded using 30 ms mixing time, 128 increments of 320 scans each. The SPINAL-64 pulse with the field strength of 71 KHz was applied during acquisition.

High-resolution NMR spectra of ArcB(1-115) expressed in E. coli were recorded at 45° C. on a Bruker 900 MHz spectrometer (KBSI, Korea). NMR spectra of TM domains of ArcB, QseC, and KdpD expressed in the CF system were recorded at 45° and 37° C. on a Bruker 700 MHz spectrometer (Salk, USA). Both spectrometers are equipped with four radio-frequency channels and a triple-resonance cryo-probe with a shielded z-gradient coil. [¹⁵N, ¹H] TROSY and TROSY-based (Pervushin, K. et al., Proc Natl Acad Sci U S A., Nov. 11, 1997, 94:12366) HNCO experiments were measured for each selectively [¹⁵N, ¹³C]-labeled sample for combinatorial assignment (see below). TROSY-based experiments HNCA, HNCO (Salzmann, M. et al., Proc Natl Acad Sci USA, Nov. 10, 1998, 95:13585), HNCACB, HNCOCA, HNCOCACB, and HNCACO (Salzmann, M. et al., J. Amer. Chem. Soc., 1999, 121:844), as well as 3D ¹⁵N-resolved TROSY-[¹H, ¹H]-NOESY (mixing time 120 ms) were used for traditional assignment of backbone ¹H, ¹⁵N, and ¹³C resonances. Partial side chain assignment was performed using a 3D ¹⁵N-resolved TROSY-[¹H, ¹H]-NOESY experiment. Torsion angle restraints were defined from the ¹³C^{α} and ¹³C^{β} chemical shift deviations from the “random coil” values (Wishart, D. S. et al., J Biomol NMR, March 1994, 4:171; Luginbuhl, P. et al., J. Magn. Reson. B., 1995, 109:229). Distance constraints for structure calculation were obtained from a 3D ¹⁵N-resolved TROSY-[¹H, ¹H]-NOESY experiment collected with the mixing time of 120 ms.

Measurement of the paramagnetic relaxation enhancement (PRE) effect was performed as described (Battiste, J. L. et al., Biochemistry, May 9, 2000, 39:5355; Roosild, T. P. et al., Science, Feb. 25, 2005, 307:1317). [¹⁵N, ¹H] TROSY spectra were measured consequently with all cysteine mutants before spin labeling, after the labeling in oxidized and reduced states, and after removal of the spin label. In order to evaluate a possible intermolecular PRE effect, additional [¹⁵N, ¹H] TROSY spectra were measured with the mixed samples containing a 1:1 mixture of uniformly ¹⁵N-labeled protein with the “cold” (not labeled with stable isotopes) spin-labeled protein. All the spectra were transformed identically, and their integral intensities were calibrated against the intensities in the spectra of the reduced samples using 8-12 cross peaks with the minimal relative signal decrease. Distance constraints were derived from the measured PRE effect according to the procedure described in (Roosild, T. P. et al., Science, Feb. 25, 2005, 307:1317).

### I. Solid State NMR Analysis of the ¹³C Chemical Shifts

Deviation of ¹³C chemical shifts from values typical for the unordered random coil structure is an ample source of information about the secondary structure of a protein (Wishart, D. S. et al., J Biomol NMR, March 1994, 4:171; Luginbuhl, P. et al., J. Magn. Reson. B., 1995, 109:229). Analysis of the deviations of characteristic chemical shifts of easily distinguishable valine and alanine ¹³C^{α} and ¹³C^{β} resonances in DARR-NMR ¹³C-¹³C correlation spectra (Takegoshi, K. et al., Chem. Phys. Lett., Aug. 31, 2001, 344:631-637) of the precipitant show that all of the detectable valines and alanines lie in the helical regions for both ArcB(1-115) and the cysteine-free mutant of KdpD(397-502), [C402,409S]-KdpD(397-502), (FIGS. 4C and 7A).

### J. Solution NMR Analysis of H-D Exchange

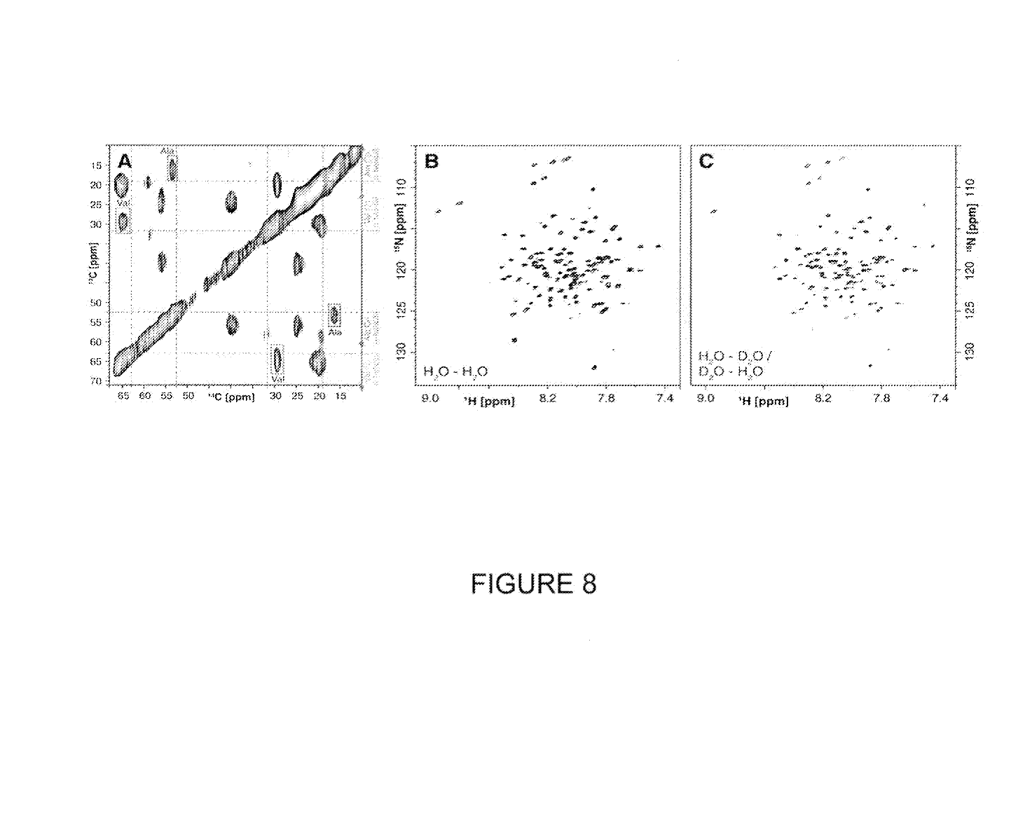

The forming of the secondary structure of the TM domains of ArcB and KdpD, which were expressed in the p-CF mode, was studied by exchange of backbone labile protons to solvent deuterons. The ¹⁵N-labeled proteins, ArcB(1-115) and [C402,409S]-KdpD(397-502) were expressed in the p-CF mode in 99% D₂O or 100% H₂O and solubilized by 5% LMPG in 100% D₂O or H₂O. A comparison of the [¹⁵N, ¹H]-TROSY-HSQC spectra shows significant differences in numbers and integral intensities of the cross-peaks depending on the history of the sample (FIGS. 8B-C and 9).

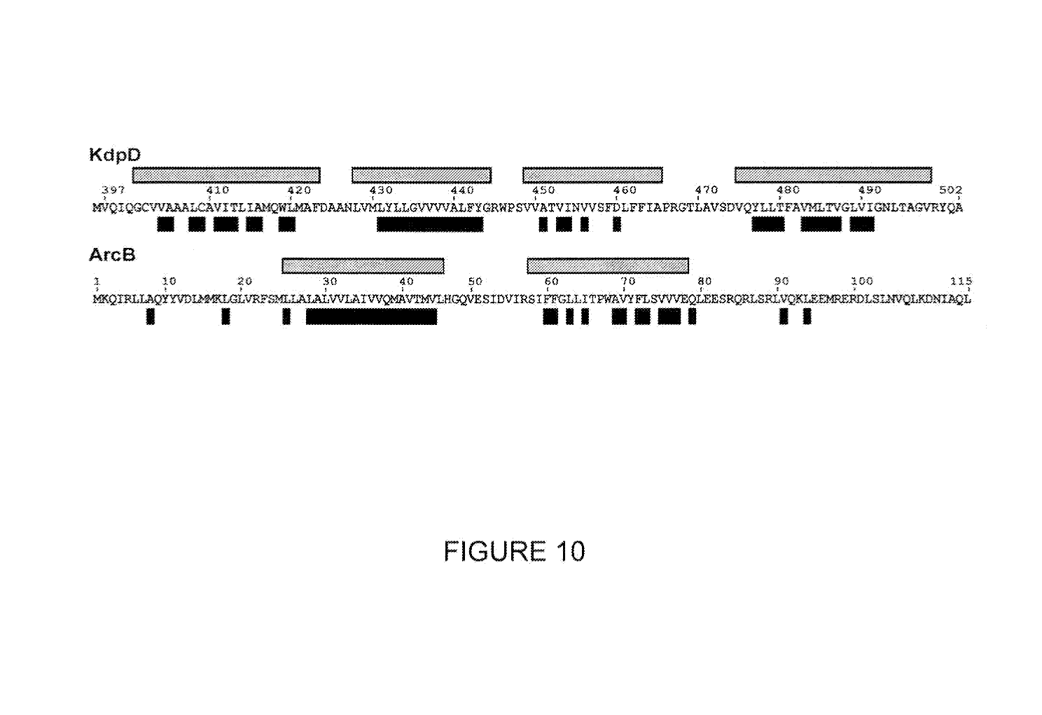

The samples, which were expressed, washed, and solubilized in the buffers with the same isotopic composition, showed 100% of the expected TROSY cross peaks (in H₂O, FIGS. 8B and 9A) or none (in D₂O, FIG. 9D), and were used as “positive” and “negative” controls, respectively. When we subsequently used the D₂O solubilization buffer for the sample expressed in H₂O, we detected cross peaks for only those H—N groups which correspond to α-helical TM regions (FIGS. 8C and 9C). Conversely, the protein expressed in D₂O after solubilization in the H₂O buffer, showed mostly cross peaks assigned to the H—N groups from loop and tail regions (FIGS. 8C and 9B), with intensities similar to the “positive” control spectrum. For the same sample, cross peaks for the H—N groups located in TM helices were either absent or lost >60% of their intensity as compared to the “positive” control. Analysis of localization of the HN protons, demonstrating slow exchange to solvent deuterons (FIG. 10), showed that the majority of backbone amide hydrogens located in the TM helices participated in stable hydrogen bonds, which are already pre-formed in a precipitated protein.

### K. Combinatorial Labeling and Assignment

For QseC(1-185) and KdpD(397-502) sequences, we designed a combinatorial labeling schemes that include amino acid-selective labeling of ¹⁵N^{H} or ¹³C^{O} atoms (Tables 2, 3). In principle, for every individual pair of residues XY, where an amino acid type “X” is labeled with a ¹³C^{O} and an amino acid type “Y” is labeled with ¹⁵N^{H}, cross peaks in both [¹⁵N-¹H]-HSQC and HNCO spectra arise (tag “2” in FIG. 4A). At the same time, for the same amino acid “Y” in another pair ZY, where ¹³C^{O} of the amino acid type “Z” is not labeled, there will only be a cross peak in the TROSY spectrum (tag “1” in FIG. 4A). For the residues which are not labeled by ¹⁵N there will be no cross peaks (tag “0” in FIG. 4A). Thus, by an analysis of the presence and absence of cross peaks in [¹⁵N-¹H]-HSQC and HNCO spectra in every sample we can define types of the amino acids for both residues in a pair. If the pair is unique in a sequence, the exact assignment of the ¹H^{N}, ¹⁵N^{H}, and ¹³C^{O} atoms to this pair of the residues is known. Usually in a 100aa protein about 40% of the pairs are unique, ˜30% are present twice in the sequence, and the remaining are present 3 or more times. Therefore, this simple analysis of two very short (about 1 h each) experiments for each combinatorially labeled sample provides an unambiguous assignment for ˜30-40% of backbone ¹H^{N}, ¹⁵N^{H}, and ¹³C^{O} resonances and defines the amino acid type for the rest of backbone ¹H^{N}, ¹⁵N^{H}, and ¹³C^{O} resonances, thus limiting the number of their possible positions in a sequence to as few as 2-4. It is important to note that the residues assigned by the combinatorial approach are usually evenly distributed in a sequence and thus form a useful set of multiple starting points for traditional sequential assignment.

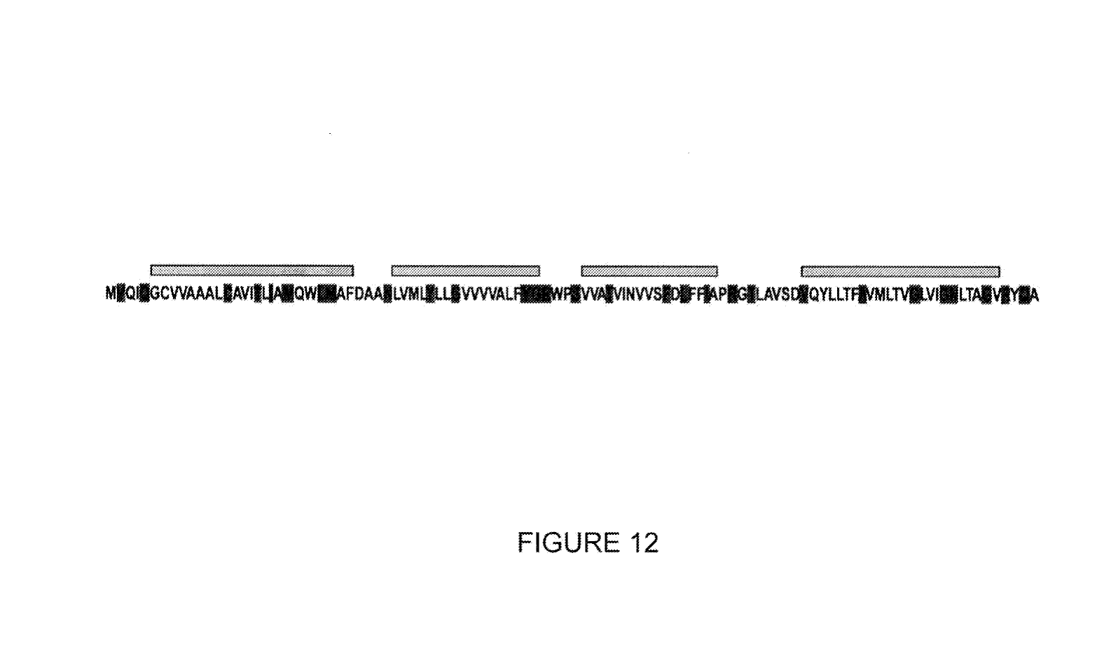

The challenge is to find a combinatorial labeling scheme in which a minimal number of samples would allow an assignment of all unique pairs in a protein sequence. Numerically, each pair of residues in a given sample is assigned a specific tag depending on its labeling combination, as explained above (see also FIG. 12). Therefore, in a sequence of combinatorially labeled samples a pair is defined by a sequence of tags, that is, a code. If the code is unique for a given pair, the assignment of the ¹H^{N} and ¹⁵N^{H} resonances to the second residue, as well as the assignment of the ¹³C^{O} resonance to the first residue of the pair, is decided. The minimal required number of samples is pre-calculated using an in-house program developed based on the Monte Carlo approach.

The assignment process is demonstrated for three KdpD(397-502) cross peaks (FIG. 4D). Here an HN cross peak for residue C is present in the TROSY spectra of samples I, III, IV, and V and in the HN plane of the HNCO spectrum of sample IV, therefore its code is 101210 (the digit place corresponds to sample number). This code is unique and corresponds to the Phe481-Ala482 pair in the sequence, which provided an unambiguous assignment for Ala482. Cross peak B has the code 021102 and was assigned to 3 possible Ala-Val pairs in the sequence (Val411/472/483). Cross peak A has the code 011101 and was assigned to 9 possible pairs, with Val as the second amino acid in every pair and Arg, Val, or Thr, not labeled by ¹³C, as the first amino acid.

All the selectively ¹⁵N- and ¹³C-labeled samples for combinatorial assignment were expressed in parallel using the p-CF expression system (see sample preparation) and solubilized simultaneously in the same buffer to eliminate any differences in cross peak positions. We used TROSY-based versions of most sensitive heteronuclear NMR experiments, [¹⁵N-¹H]-HSQC and 2D HNCO. Therefore, low amounts of protein (0.4-0.6 ml of reaction mixture for each combinatorially labeled sample) were enough to measure short experiments (about ½-1½ hour each). All the samples for the combinatorial assignment of a particular protein were measured in only 1-2 days, depending on the actual concentration of the protein. The assignment and analysis of spectra were performed using the CARA program (Keller, R. The Computer Aided Resonance Assignment Tutorial (CANTINA Verlag, 2004)).

### L. Structure Calculation

An interactive procedure, which included structure calculation by the CYANA program (Guntert, P. Methods Mol. Biol., 2004, 278:353) followed by the assignment and distance constraints refinement, was used to calculate the backbone spatial structures of ArcB(1-115), QseC(1-185), and KdpD(397-502). Distance constraints used for structure calculation were derived from the integral intensities of NOE cross-peaks measured in 3D ¹⁵N-resolved TROSY-[¹H, ¹H]-NOESY (mixing time 120 ms), and from the PRE data (see above). Torsion angle constraints were added for all residues with ¹³C^{α} chemical shifts deviating from the random coil values by more than 1.5 ppm with the following bounds: 90°<φ<30° and −80°<ψ<20° for deviations>1.5 parts per million (Luginbuhl, P. et al., J. Magn. Reson. B., 1995, 109:229), while no regular (for more than 2 consecutive residues) deviations<1.5 ppm were detected. The summary of constraints used in calculation of the structures is presented in Table 4.

The 20 conformers with the lowest target function of the last CYANA calculation cycle were energy-minimized using CNS program (Brunger, A. T. et al., Acta Crystallogr D Biol Crystallogr., Sep. 1, 1998, 54:905). The residual constraint violations and conformational energy terms in the final sets of the structures are small (Table 4), thus confirming the validity of the obtained data sets and compatibility of the restraints with the obtained structures. The backbone root-mean-square-deviation (RMSD) values calculated for the TM helical regions (Table 4) allowing definitions of the positions of the ArcB and KdpD TM helices accurately, while the position and orientation of the second helix in the QseC TM domain was defined with low resolution. The coordinates of the structures have been deposited in the Protein Data Bank (ArcB, 2ksd; QseC, 2kse; KdpD, 2ksf).

TABLE 1
Site-directed mutagenesis of ArcB(1-115), QseC(1-
185), and KdpD(397-502). Cysteine residues
used for labeling with MTSL are marked.

| ArcB(1-115) | QseC(1-185) | KdpD(397-502) | KdpD-CS(397-502) |
|---|---|---|---|
| F23C | S9C | C402S (409C) | Q398C |
| S52C | Q36C | C402S, C409S (CS) | A425C |
| Q79C | T93C | | S448C |
| | M156C | | T469C |
| | Q164C | | Q501C |
| | A171C | | |
| | M179C | | |

TABLE 2
Combinatorial selective ¹⁵N, ¹³C labeling scheme for QseC(1-185). For each
combinatorially labeled sample (I-VII): N denotes ¹⁵N-labeling, C - 1-¹³C-labeling,
and a blank cell means that the amino acid was not labeled in the sample.

| | A | D | E | F | G | I | K | L | M | N | P | Q | R | S | T | V | W | Y |
|---|---|---|---|---|---|---|---|---|---|---|---|---|---|---|---|---|---|---|
| I | C | N | C | C | N | N | C | N | C | N | C | N | N | N | N | C | C | C |
| II | N | C | C | N | C | C | C | N | C | N | C | N | N | C | | N | N | C |
| III | N | N | C | C | N | N | N | N | C | | | | | C | N | C | N | N |
| IV | N | N | N | C | N | C | C | N | C | N | C | N | | N | | N | C | C |
| V | N | N | C | C | N | C | N | C | N | | C | N | N | N | N | N | C | C |
| VI | N | N | N | N | C | N | N | C | N | | C | | N | C | N | C | C | C |
| VII | C | C | N | N | N | N | N | C | N | | | | | C | N | C | N | N |

TABLE 3
Combinatorial selective ¹⁵N, ¹³C labeling scheme for KdpD(397-502). For each
combinatorially labeled sample (I-VI): N denotes ¹⁵N-labeling, C - 1-¹³C-labeling,
and a blank cell means that the amino acid was not labeled in the sample.

| | A | C | D | F | G | I | L | M | N | P | Q | R | S | T | V | W | Y |
|---|---|---|---|---|---|---|---|---|---|---|---|---|---|---|---|---|---|
| I | N | | C | N | N | N | C | C | | | N | N | | N | C | | N |
| II | C | C | C | N | N | N | N | C | N | C | N | | N | N | N | | C |
| III | N | C | N | N | N | C | C | N | N | C | | N | C | N | N | | C |
| IV | N | N | N | C | C | N | N | C | | | N | | C | N | N | C | N |
| V | N | C | | | C | N | N | N | | | N | | | | C | N | C |
| VI | C | | | | | | N | | | | | | C | | N | | |

TABLE 4
Summary of statistics for the calculated sets of 20 lowest energy
structures of ArcB(1-115), QseC(1-185), and KdpD(397-502).

| | ArcB(1-115) | QseC(1-185) | KdpD(397-502) |
|---|---|---|---|
| Structural constraints | | | |
| Distance constraints | | | |
| NOE | 218 | — | — |
| PRE | 221 | 281 | 323 |
| Hydrogen bonds | 31 | 28 | 56 |
| Torsion angle constraints | | | |
| Phi | 37 | 42 | 72 |
| Psi | 37 | 42 | 71 |
| Structural statistics^{a} | | | |
| Structures in the final | 20 | 20 | 20 |
| set | | | |
| Violations (mean ± s.d.) | | | |
| Distance constraints (Å) | 0.17 ± 0.01 | 0.21 ± 0.03 | 0.22 ± 0.02 |
| Torsion angle constraints | 1.74 ± 0.30 | 2.12 ± 0.40 | 1.81 ± 0.51 |
| (°) | | | |
| Backbone r.m.s.d. (Å) | | | |
| Average pairwise in the | 1.45 ± 0.45 | 2.35 ± 0.85 | 1.61 ± 0.48 |
| set | | | |
| To the mean structure | 1.41 ± 0.46 | 2.18 ± 0.86 | 1.56 ± 0.49 |
| Equivalent resolution (Å) | 2.9 | 3.2 | 2.7 |

^{a}Calculated by PROCHECK program (Laskowski, R. A. et al., Journal of Applied Crystallography, 1993, 26: 283)

TABLE 5
Packing of TM helical domains^{a}

| | TM | Bend/kink | Packing | |
|---|---|---|---|---|
| | helixes | angle | angle | Distance |
| ArcB(1-115) | 25-45 | 8.17 ± 2.88 | 142.0 ± 6.5 | 11.09 ± 0.98 |
| | 58-77 | 22.38 ± 2.15 | | |
| QseC(1-185) | 14-34 | 9.99 ± 2.19 | 156.5 ± 4.19 | 11.64 ± 1.04 |
| | 159-180 | 25.78 ± 3.37 | | |
| KdpD | 400-421 | 9.19 ± 2.17 | −168.2 ± 3.6; | 7.50 ± 2.16 |
| (397-502) | | | 21.8 ± 5.3; | (1-2) |
| | | | −156.6 ± 4.1 | |
| | 428-445 | 10.19 ± 2.66 | −164.7 ± 5.6; | 9.36 ± 0.93 |
| | | | 24.5 ± 4.9 | (2-3) |
| | 449-464 | 9.19 ± 3.90 | −154.1 ± 5.7 | 10.26 ± 0.48 |
| | | | | (3-4) |
| | 476-497 | 9.61 ± 3.19 | | 8.81 ± 1.93 |
| | | | | (1-4) |

^{a}Parameters of helix-helix packing were calculated for the final sets of structures using the helix-pairs program (Dalton, J. A. et al., Bioinformatics, Jul 1, 2003, 19: 1298).

References for structures of HKR's Domains: Etzkorn, M. et al., Nat Struct Mol. Biol., October 2008, 15:1031; Rogov, V. V. et al., J Mol Biol., Nov. 17, 2006, 364:68; Marina, A. et al., J Biol. Chem., Nov. 2, 2001, 276:41182; Tanaka, T. et al., Nature, Nov. 5, 1998, 396:88; Tomomori, C. et al., Nat Struct Biol., August 2009, 6:729; Ikegami, T. et al., Biochemistry, Jan. 16, 2001, 40:375; Kato, M. et al., Cell, Mar. 7, 1997, 88:717; Rogov, V. V. et al., J Mol. Biol., Oct. 29, 2004, 343:1035; Xie, W. et al., (submitted); Pappalardo, L. et al., J Biol. Chem., Oct. 3, 2003, 278:39185; Cheung, J. C. et al., J Biol. Chem., May 16, 2008, 283:13762; Cheung, J. et al., Structure, Feb. 13, 2009, 17:190; and Moore, J. O. et al., Structure, Sep. 9, 2009, 17:1195.

### Example 2

About 30% of the human genome code for membrane proteins. These human integral membrane proteins (hIMPs), situated in the physical barrier between the cell and its surrounding, play critical roles in metabolic, regulatory, and intercellular processes, including neuronal signaling, intercellular signaling, cell transport, metabolism, and regulation. They are targeted by ˜40% of today's major therapeutic drugs. However, difficulties in handling hIMPs hamper functional and structural studies and slow down the progress of drug development. In fact, fewer than 25 structures of hIMPs are currently deposited in the Protein Data Bank. These difficulties are associated with hIMP expression, with hIMP purification and crystallization for X-ray structural studies, and with protein labeling to achieve good spectral quality for solution NMR studies.

A lack of efficient production systems is one of the main bottlenecks in the studies of hIMPs. The cellular prokaryotic expression systems do not have compatible translocation machineries to express hIMPs, and eukaryotic systems are expensive and difficult to handle. E. coli based cell-free (CF) expression systems have recently been shown to overcome IMP expression limitations observed in prokaryotic in vivo expression systems. See e.g., Klammt, C. et al., Eur J Biochem., February 2004, 271:568. Because of the absence of any hydrophobic compartment or translocation, IMPs precipitate during CF expression but can be subsequently solubilized in mild detergents, referred to as precipitating cell-free (P-CF) mode. See e.g., Klammt, C. et al., Ibid. This contrasts with other modes of expression, by the addition of surfactants, such as detergents (surfactant cell-free, S-CF mode), or lipids (lipid cell-free, L-CF mode) that may enable direct soluble expression of IMPs. See e.g., Klammt, C. et al., Ibid; Ishihara, G. et al., Protein Expr Purif., May 2005, 41:27; Klammt, C. et al., Febs J., December 2005, 272:6024; Kalmbach, R. et al., J Mol Biol., Aug. 17, 2007, 371:639; Katzen, F. et al., J Proteome Res., August 2008, 7:3535. We have extensively optimized P-CF expression for membrane protein production, and it has proven to be very efficient producing folded IMPs. See e.g., Maslennikov, I. et al., Proc Natl Acad Sci USA, Jun. 15, 2010, 107:10902. Additionally, it has been shown that several GPCRs and transporters expressed in the CF system have functional characteristics. See e.g., Ishihara, G. et al., Protein Expr Purif., May 2005, 41:27; Klammt, C. et al., Febs J., July 2007, 274:3257; Keller, T. et al., Biochemistry, Apr. 15, 2008, 47:4552; Junge, F. et al., J Struct Biol., May 2010, 172:94.

The open nature of the CF system enables the system to be synergistic to solution NMR, one of the principal experimental techniques in structural biology. 3-D structure determination of membrane proteins by solution NMR (Hiller S., et al., Science, August 2008, 321:1206; Van Horn W. D., et al., Science, June 2009, 324:1726) expanded the boundaries of NMR applicability to large systems by TROSY-based experiments (Pervushin R., et al., Proc Natl Acad Sci USA, November 1997, 94:12366; Riek R., et al., J Am Chem. Soc., October 2002, 124:12144. In addition to these advancements on CF and solution NMR methods, the difficulties associated with laborious and time consuming resonance assignment due to strong signal overlap caused by the internal mobility of TM helical bundles and low dispersion of the chemical shifts in IMPs have been addressed by developing the CF combinatorial dual-labeling (CDL) strategy. See e.g., Maslennikov, I. et al., Proc Natl Acad Sci USA, Jun. 15, 2010, 107:10902. CDL greatly accelerates resonance assignment and subsequent data analysis. Finally, technological limitations in the detection of long-range interactions to build a 3D structure have been addressed by the measurement of paramagnetic relaxation enhancement (PRE) by an external or covalently-bound paramagnetic group (Battiste J. L. & Wagner G., Biochemistry, May 2000, 39:5355; Roosild T. P., et al., Science, February 2005, 307:1317) and the measurement of long range Nuclear Overhouser Enhancement (NOE) data using deuterated and selectively protonated proteins solubilized in deuterated detergents. In this report we show that the powerful synergy between CF and NMR implemented by the CDL strategy led to the structure determination of 6 solution structures within less than an 18 month period.

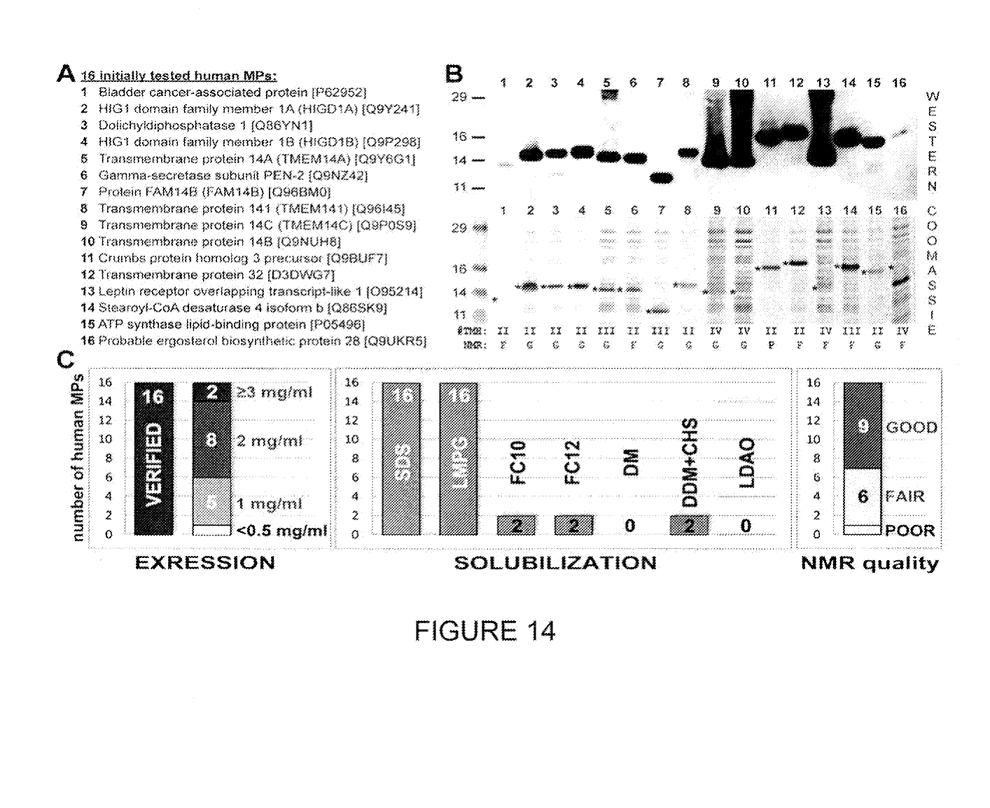

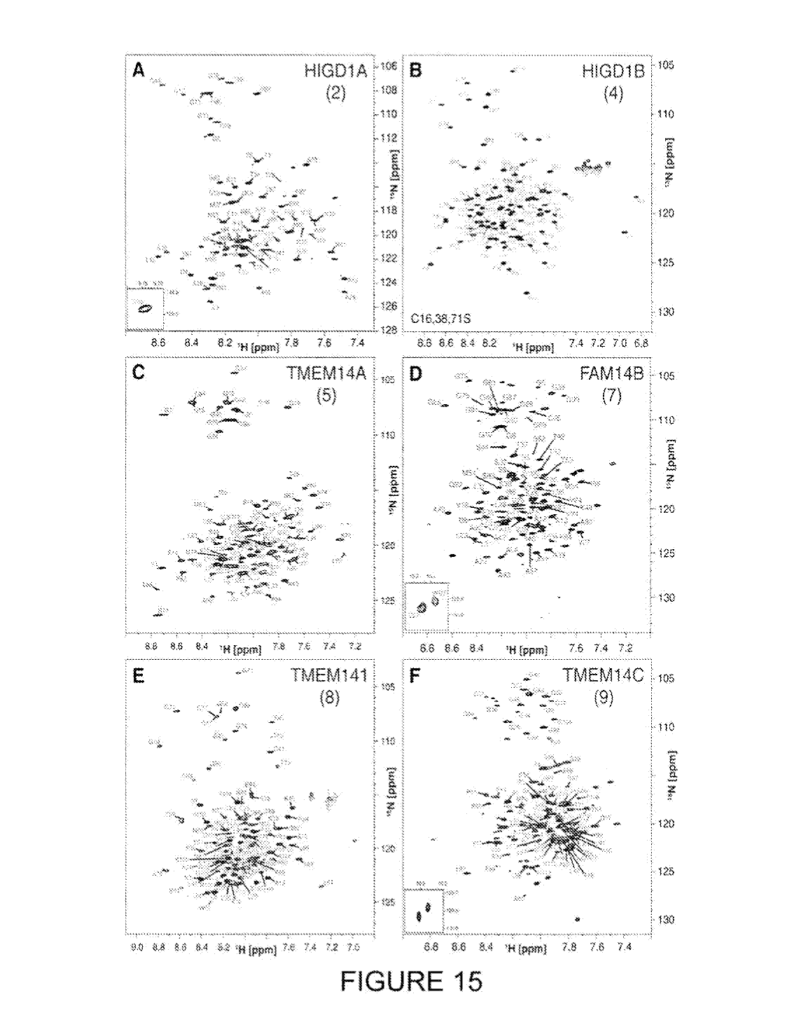

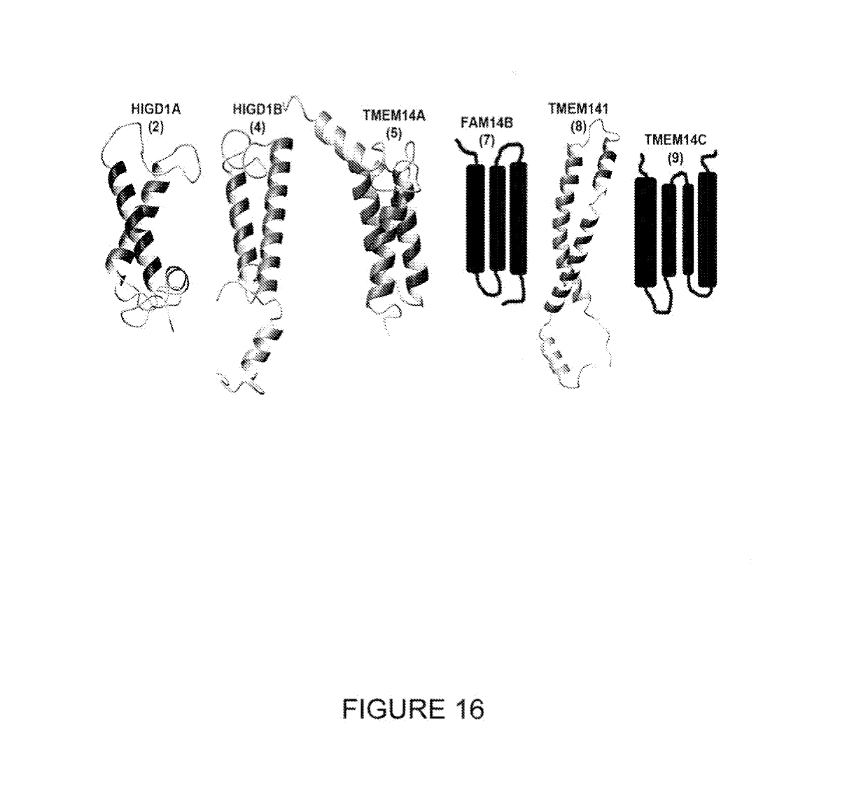

We have initially selected 16 genes with unknown functions that encode small size (<20 kDa) hIMPs (FIG. 14A). All but one expressed at high levels in our E. coli-based P-CF system (FIG. 14B). Targets expressed in the P-CF mode were subsequently screened for solubilization in 7 different detergents (FIG. 14C). To evaluate NMR spectral quality, the precipitate of uniformly ¹⁵N-labeled hIMPs was washed and then solubilized in the lipid-derived detergent 1-myristoyl-2-hydroxy-sn-glycero-3-[phospho-rac-(1-glycerol)] (LMPG). LMPG has been found most effective in detergent solubilization screens, resulting in a sample ready for NMR studies without additional purification steps. The P-CF mode enabled us to obtain NMR-ready samples within 24 hours after setting up CF expression because it bypasses purification steps. [¹H-¹⁵N]-TROSY fingerprint spectra were recorded and spectral quality was evaluated and scored in three categories (good/fair/poor) according to the number of visible glycine and indol tryptophan H—N resonances, as well as the total number of cross peaks, their chemical shift dispersion, and uniformity of line shapes. From all 16 hIMP preparations, we obtained 9 good candidates for additional NMR studies. Six hIMPs among them have then progressed to N—H assignment (FIG. 15) and their backbone structures have been determined following methods described in [Maslennikov 2010]. These structures of hIMPs are all composed of helical bundles, which are packed and have helical lengths consistent with the membrane localization of these proteins (FIG. 16).

All 6 hIMPs reported herein have no known function. Without wishing to be bound by any theory, it is believed that HIGD1A and HIGD1B are most likely associated with hypoxia. Polyclonal antibodies for both proteins have been created by using P-CF expressed and detergent solubilized hIMPs (Eton Bioscience). Protein FAM14B, also named interferon alpha-inducible protein 27-like protein 1 belongs to the Interferon-induced 6-16 family. Transmembrane protein 141 belongs to the TMEM141 protein family. Transmembrane protein 14A and transmembrane protein 14C both belong to the yet uncharacterized protein family UPF0136_TM.

The success of the preliminary studies encouraged us to seek a bigger coverage of the hIMP proteome. Out of 3,710 hIMP cDNA library we have selected additional 134 targets from the 10-30 kDa range and 50 targets from 30-115 kDa range for expression screening and evaluation of protein quality. 110 out of totally 150 selected targets from 10-30-kDa range expressed at a level >1 mg/ml of CF reaction mixture. LMPG was found to solubilize all 150 expressed proteins. 31 targets out of 50 selected proteins with molecular weight >30 kDa also expressed at a level >1 mg/ml of CF reaction mixture. Thus, we confirmed that the size of the protein is not a critical factor in CF expression as previously concluded for E. coli IMPs. See e.g., Schwarz, D. et al., Proteomics, May 2010, 10:1762. In total, 141 out of 200 targets (71%) of hIMPs have been expressed in P-CF mode in quantities >1 mg per ml of the CF reaction mixture. TROSY-HSQC spectra show that 32 out of 82 targets tested by NMR are reasonably adequate for structural studies without further optimization.

This high speed method aided by CDL strategy is possible because of the powerful technological synergy between CF and solution NMR. It opens up new possibilities to study hIMPs. Although elucidation of the biological function of these proteins awaits further characterization, the six new backbone structures now provide an additional 25% to the current PDB entries of hIMPs and provide modeling leverage for more than 300 sequences. Our results suggest that the speed of the methods will likely extend its potential applications beyond the solution NMR structural studies of hIMPs, such as biological characterization of these CF expressed hIMPs, individual antibody production against hIMP for proteomic and cell biological studies, as well as bio-nanomaterial studies.

1. A method for determining structural information for an amino acid sequence, the method comprising the steps of:
i. determining a plurality of different isotopic labeling schemes for an amino acid sequence;
ii. synthesizing a plurality of isotopically labeled peptides, wherein each isotopically labeled peptide is isotopically labeled according to one of the plurality of different isotopic labeling schemes and wherein each isotopically labeled peptide comprises the amino acid sequence; and
iii. subjecting the plurality of isotopically labeled peptides to an NMR spectroscopic analysis thereby determining structural information for the amino acid sequence.

2. The method of claim 1, wherein the plurality of different isotopic labeling schemes are ¹⁵N and ¹³C isotopic labeling schemes.

3. The method of claim 1, wherein the plurality of different isotopic labeling schemes are ¹⁵N^{H} and ¹³C^{O} isotopic labeling schemes.

4. The method of claim 1, wherein the NMR spectroscopic analysis comprises HNCO NMR spectroscopic analysis, HSQC NMR spectroscopic analysis, or a combination thereof.

5. The method of claim 1, wherein the determining comprises minimizing NMR spectra peak abundance.

6. The method of claim 1, wherein the determining comprises minimizing NMR spectra peak overlap.

7. The method of claim 1, wherein the determining comprises predicting an NMR peak assignment for an amino acid in the amino acid sequence.

8. The method of claim 1, wherein the amino acid sequence is a membrane protein sequence.

9. The method of claim 1, wherein the determining comprises limiting the plurality of different isotopic labeling schemes to less than 20 different isotopic labeling schemes.

10. The method of claim 1, wherein the plurality of different isotopic labeling schemes ranges in number from 5 to 10.

11. The method of claim 1, wherein the plurality of different isotopic labeling schemes is 6 or 7 in number.

12. A computer-implemented method for determining a plurality of different isotopic labeling schemes, the method comprising:
under the control of one or more computer systems configured with executable instructions;
receiving user input specifying an amino acid sequence and an integer representing a number of different isotopic labeling schemes for the amino acid sequence;
determining each of the number of different isotopic labeling schemes for the amino acid sequence; and
providing data to a user, the data identifying each of the number of different isotopic labeling schemes for the amino acid sequence.

13. The method of claim 12, wherein the determining comprises predicting an NMR peak assignment for an amino acid in the amino acid sequence.

14. The method of claim 12, wherein the determining comprises minimizing NMR spectra peak overlap.

15. The method of claim 12, wherein the determining comprises removing redundant isotopic labeling schemes from the number of different isotopic labeling schemes for the amino acid sequence.

16. The method of claim 12, wherein the determining comprises predicting an absence of an NMR cross-peak or a presence of an NMR cross-peak, wherein the absence and the presence is assigned to a pair of consecutive amino acids in the amino acid sequence.

17. The method of claim 16, wherein a unique tag is assigned to each pair of amino acids in the amino acid sequence based on the absence or the presence.

18. The method of claim 12, wherein the different isotopic labeling schemes are ¹⁵N and ¹³C isotopic labeling schemes.

19. (canceled)

20. (canceled)

21. (canceled)

22. (canceled)

23. (canceled)

24. (canceled)

25. (canceled)

26. (canceled)

27. A computer-readable storage medium having stored thereon instructions that, when executed by one or more processors of a computer system, cause the computer system to at least:
receive a user input specifying an amino acid sequence and an integer representing a number of different isotopic labeling schemes for the amino acid sequence;
determine each of the number of different isotopic labeling schemes for the amino acid sequence; and
provide data to a user, the data identifying each of the number of different isotopic labeling schemes for the amino acid sequence.

28. A system for determining a plurality of different isotopic labeling schemes, comprising:
one or more processors; and
memory including instructions executable by the one or more processors that, when executed by the one or more processors, cause the system to at least:
receive a user input specifying an amino acid sequence and an integer representing a number of different isotopic labeling schemes for the amino acid sequence;
determine each of the number of different isotopic labeling schemes for the amino acid sequence; and
provide data to a user, the data identifying each of the number of different isotopic labeling schemes for the amino acid sequence.
